(19) United States
(12) Patent Application Publication
(10) Pub. No.: US 2011/0016042 A1
(43) Pub. Date: Jan. 20, 2011

(54) SYSTEM AND METHOD FOR TRACKING AND ANALYZING LOANS INVOLVED IN ASSET-BACKED SECURITIES

(75) Inventors: Soogyung Cho, New York, NY (US); Matt R. Schwab, McKinney, TX (US); Kerry Lee Williams, Irvine, CA (US)

Correspondence Address: KNOBBE MARTENS OLSON & BEAR LLP, 2040 MAIN STREET, FOURTEENTH FLOOR, IRVINE, CA, 92614, US

(73) Assignee: EXPERIAN INFORMATION SOLUTIONS, INC., Costa Mesa, CA (US)

(21) Appl. No.: 12/933,073

(22) PCT Filed: Mar. 18, 2009
(86) PCT No.: PCT/US09/37565

§ 371 Date: Sep. 16, 2010

Related U.S. Application Data
(60) Provisional application No. 61/100,662, filed on Sep. 26, 2008.
(60) Provisional application No. 61/037,977, filed on Mar. 19, 2008.

(30) Foreign Application Priority Data
May 21, 2008 (US) 12124613

(51) Int. Cl. G06Q 40/00

(52) U.S. Cl. 705/38

(57) ABSTRACT

Embodiments of the disclosure are directed to providing unique loan identifiers to track loans involved in Asset-Backed Securities (ABS) throughout the life-cycle of the individual loans, in one embodiment, a unique loan identifier, for example, a loan number, may be appended to loan data at initiation of each loan, for example, at the application stage, to and/or beyond the retirement of the loan. The unique loan identifiers may allow disparate financial data sources such as the credit histories of the borrowers to be associated with the individual loans, even as the loans are repackaged and resold as ABS in the secondary markets. Thus, market participants such as loan servicers and investors can access current and historical data associated with the loans. Other embodiments are directed to analyzing the data associated with the underlying loans and providing the analysis to the market participants including servicers, investors, and underwriters.

### BACKGROUND

1. Field of the Invention

This disclosure relates in general to computer data processing, and in particular to computer based tracking and analysis of loans and/or assets involved in asset-backed securities.

2. Description of the Related Art

Asset-Backed Securities (ABS) are securitized interests that are based on pools of financial assets. These assets may include mortgages and other receivables such as credit card receivables, auto loans, manufactured-housing contracts, student loans, home-equity loans, timeshares and memberships. As used herein, the term ABS also encompasses Mortgage-Backed Securities (MBS), Collateralized Debt Obligations (CDO), Collateralized Loan Obligations (CLO), and other similar collateralized or uncollateralized loan-based securities. One goal of securitization of these assets is to make them available for investment to a broader set of investors. However, investors often have little or no access to information relating to the underlying assets and, thus, must rely on credit rating agencies to determine the credit-worthiness of each individual ABS. Such rating systems are not always reliable, and when they fail to predict failures, investors can lose confidence, leading to a loss of flow of capital into the entire ABS market.

### SUMMARY OF THE DISCLOSURE

Embodiments of the disclosure are directed to providing unique loan identifiers to track loans involved in ABS throughout the life-cycle of the individual loans. The terms “loan” or “loans” as used in the disclosure cover any type of financial payment or repayment obligations including residential loans, commercial loans, leases, account payables and other types of income payment or repayment schemes and arrangements. In one embodiment, a unique loan identifier, for example, a loan number, may be appended to loan data at initiation of each loan, for example, at the application stage, to and/or beyond the retirement of the loan. The unique identifiers may allow disparate financial data sources such as the credit histories of the borrowers to be associated with the individual loans, even as the loans are repackaged and resold as ABS in the secondary markets. Thus, market participants such as loan servicers, trustees, and investors can access current and historical data associated with the obligors (i.e., borrowers) and collaterals underlying the loans, other information such as the identity and performance of the servicers or sub-servicers, the trustee, the mortgage broker, and the originator, and time stamp information. Other information processed and/or tracked in various embodiments includes data related to borrowers, assets, loans, deals, structure, securities. Securities data may include but are not limited to data related to mortgage broker, underwriter, date and time, process used, and product.

Other embodiments are directed to analyzing the data associated with the underlying loans and providing the analysis to the market participants including servicers, investors, and underwriters. In various embodiments, the underlying assets may encompass real estate assets, automobiles, loans, leases, inventory, and/or earnings from multi-media assets such as movies.

One embodiment is a computerized system for analyzing loans involved in asset-backed securities and various aspects of the asset-backed securities. The computerized system comprises a credit migration database that stores consumer credit and financial data; a data repository that assigns a securitization ID to a loan and associates the securitization ID to a credit data record in the credit migration database that is associated with a borrower of the loan, and a tracking and analysis module that, upon request, analyzes one or more loans. In this embodiment, the tracking and analysis module uses the respective loan securitization IDs to: (1) retrieve the credit data records of the borrowers of the loans from the credit migration database before, during, or after a process in which the loans are securitized as asset-backed securities, (2) calculate a loan default risk or a prepayment risk based on payment records and account tradeline information within the credit data records that are associated with the borrowers, and (3) store the loan default risk or a prepayment risk in the data repository. The computerized system may also include a portal interface through which authorized users can access at least the loan default risk or a prepayment risk stored in the data repository, wherein the portal interface is configured to provide data or analytics to the authorized users via one or more network connections. In other embodiments, the system may be customized so that a data provider may connect its input data sources to the system, and the system may provide customized output data and analytics based on modeling and/or calculations performed on the data provider's input data sources and other additional data sources.

In other embodiments, the loan default risk may be calculated based on one or more of the following: historical loan performance, borrower default risk, relevant data points such as risky transactions, excessive moves, fraud flags, collateral information, and various analytics stored in the computerized system. In addition to analyzing loans involved in asset-backed securities, the computerized system also analyzing a number of other aspects related to asset-backed securities, such as borrowers associated with the loan, the underlying collateral, the participants in packaging, and the processing of the loans. Also, the credit migration database may store, in addition to consumer credit and financial data, any other data ancillary to the ecosystem of the loan, such as time stamp and party who has processed or is related to the loan.

Another embodiment is a method of analyzing performance of loans and borrower credit profiles involved in asset-backed securities, comprising assigning a unique loan identifier to each of a plurality of loans; associating one or more borrower credit data records with each of the loan identifiers; after the loans have been issued and securitized as asset-backed securities, using the loan identifiers to retrieve the credit data records of the respective borrowers of the plurality of loans; and analyzing the loans based on the retrieved credit data records of the borrowers.

Another embodiment is a computerized system for analyzing loans involved in asset-backed securities, comprising: a data repository that assigns a unique loan identifier to each of a plurality of loans and associates each loan identifier to one or more credit data records of the respective borrowers of the loans; and a tracking and analysis module that, upon request, analyzes a first plurality of the loans that have been combined into an asset-backed security, wherein the tracking and analysis module uses the loan identifiers associated with the first plurality of loans in order to: retrieve credit data records of the borrowers associated with the first plurality of loans after the loans have been securitized as asset-backed securities, analyze the performance of the first plurality of loans based on the retrieved credit data records, and provide the performance analysis to one or more entities that are authorized to receive the performance analysis.

Another embodiment is a computer program product comprising a computer usable medium having control logic stored therein for causing a computer to track and analyze loans involved in asset-backed securities, comprising: a first computer readable program code means for causing the computer to assign a unique loan identifier to each of a plurality of loans; a second computer readable program code means for causing the computer to associate one or more borrower credit data records with each of the loan identifiers; a third computer readable program code means for causing the computer to use the loan identifiers to retrieve the credit data records of the respective borrowers of the plurality of loans after the loans have been issued and securitized as asset-backed securities; and a fourth computer readable program code means for causing the computer to analyze the loans based on the retrieved credit data records of the borrowers.

### BRIEF DESCRIPTION OF THE DRAWINGS

Specific embodiments of the invention will now be described with reference to the following drawings, which are intended to illustrate embodiments of the invention, but not limit the invention:

FIG. 1 is a block diagram illustrating one embodiment of a loan tracking and analysis system;

FIG. 2 is a flow diagram illustrating an overview of the system and method according to one embodiment;

FIG. 3 is a flow diagram illustrating one embodiment of a method for loan tracking;

FIG. 4A is a block diagram illustrating one embodiment of a system and method for ABS tracking and analysis;

FIG. 4B is a block diagram illustrating one embodiment of a system and method for loan identifier assignment;

FIG. 4C is a block diagram illustrating an example data structure for tracking and analyzing loans involved in ABS;

FIG. 4D is a flow diagram illustrating one embodiment of a method of tracking and analyzing loans involved in ABS;

FIG. 5 is a block diagram illustrating data sources used in the system in accordance with one embodiment;

FIG. 6A is a block diagram illustrating one embodiment of a system and method for processing credit data migration into the loan tracking and analysis system;

FIGS. 6B-1 to 6B-4 show sample outputs from the process of credit data migration;

FIG. 7A is a block diagram illustrating one embodiment of a system and method for defining and sending trigger-based notifications;

FIG. 7B illustrates sample triggers according to an embodiment;

FIG. 8 shows a portal interface embodiment that is usable to access certain ABS analytics data;

FIGS. 9-1 to 9-4 show example outputs of the portfolio management interface according to an embodiment;

FIG. 10 illustrates the loan level detail provided by the loan management scorecard interface according to an embodiment;

FIGS. 11A and 11B show a sample view of the dashboard interface according to an embodiment;

FIG. 12 shows a sample output of a geographical portfolio analysis according to one embodiment;

FIG. 13 illustrates the process of loan securitization in accordance with one embodiment;

FIG. 14 illustrates an embodiment of a managed structured product platform according to one embodiment;

FIGS. 15-18 list the data fields used by the data repository in accordance with one embodiment; and

FIG. 19 illustrates a linkage hub architecture in one embodiment.

### DETAILED DESCRIPTION OF THE PREFERRED EMBODIMENT(S)

Preferred embodiments will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments. Furthermore, embodiments may include several novel features, no single one of which is solely responsible for its desirable attributes or which is essential to practicing the inventions herein described.

System Implementation

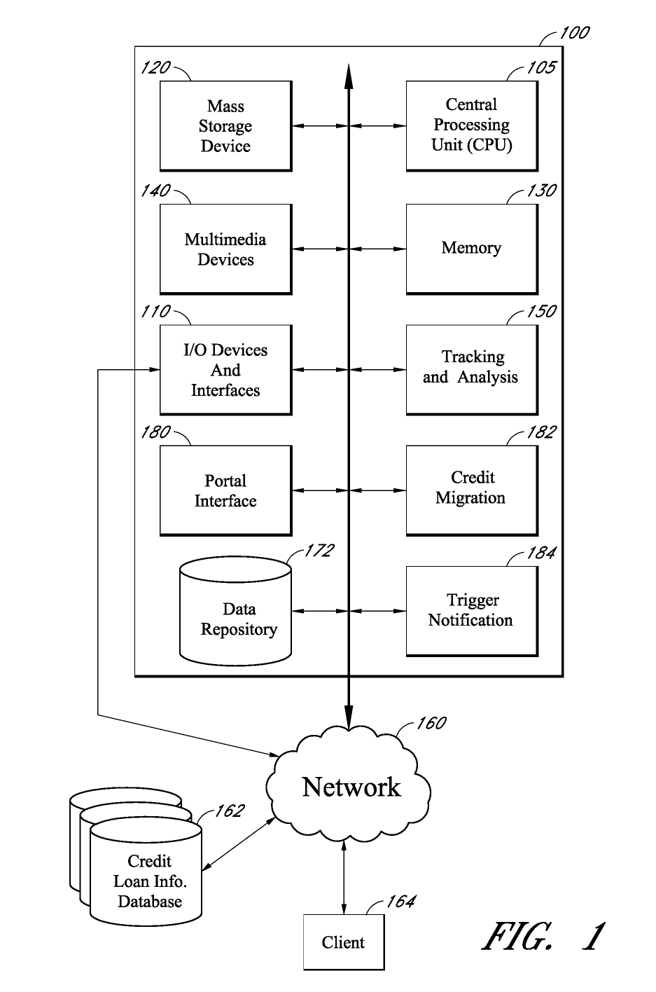

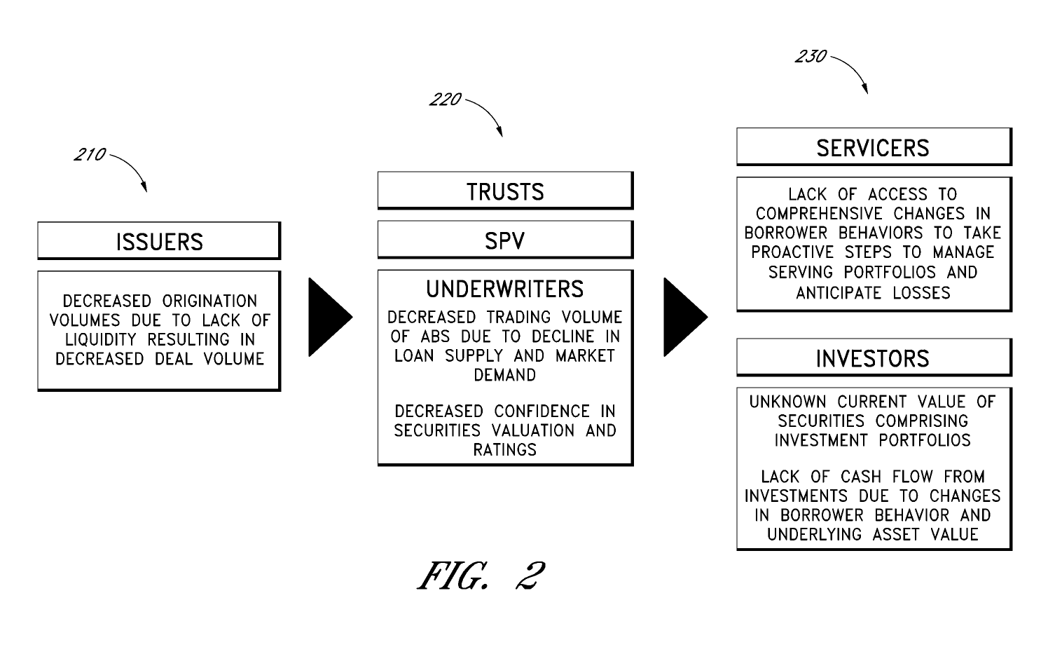

FIG. 1 is a block diagram showing an embodiment in which a loan tracking and analysis system 100 is in communication with a network 160 and various systems are also in communication with the network 160. The loan tracking and analysis system 100 may be used to implement certain systems and methods described herein. For example, the loan tracking and analysis system 100 may be configured to receive financial and demographic information regarding individuals and generate reports and/or alerts for one or more clients. Although the description provided herein refers to individuals, consumers, or customers, the terms “individual,” “consumer,” “borrower,” and “customer” should be interpreted to include applicants, or groups of individuals or customers or applicants, such as, for example, married couples or domestic partners, organizations, groups, and business entities. The loan tracking and analysis system 100 may be used to track and analyze various aspects of securitization process, including data that are ancillary to loans and collaterals such as macro economic data or historical loan performance data. Also, although the following description provides example embodiments that track and analyze residential mortgages, embodiments are not limited to tracking loans related to residential real property and are applicable to the tracking and analysis of securities that are based on other assets such as commercial properties, automobiles, loans, leases, inventory, and/or earnings from multi-media assets such as movies.

The loan tracking and analysis system 100 includes, for example, a personal computer that is IBM, Macintosh, or Linux/Unix compatible. In one embodiment, the loan tracking and analysis system 100 comprises a server, a laptop computer, a cell phone, a personal digital assistant, a kiosk, a mobile device, a Blackberry, or an audio player, for example. In one embodiment, the sample loan tracking and analysis system 100 includes a central processing unit (“CPU”) 105, which may include a conventional microprocessor. The loan tracking and analysis system 100 further includes a memory 130, such as random access memory (“RAM”) for temporary storage of information and a read only memory (“ROM”) for permanent storage of information, and a mass storage device 120, such as a hard drive, diskette, or optical media storage device. Typically, the modules of the loan tracking and analysis system 100 are connected to the computer using a standard based bus system. In different embodiments, the standard based bus system could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of loan tracking and analysis system 100 may be combined into fewer components and modules or further separated into additional components and modules.

The loan tracking and analysis system 100 is generally controlled and coordinated by operating system software, such as Windows Server, Linux Server, Windows 98, Windows NT, Windows 2000, Windows XP, Windows Vista, Unix, Linux, SunOS, Solaris, or other compatible server or desktop operating systems. In Macintosh systems, the operating system may be any available operating system, such as MAC OS X. In other embodiments, the loan tracking and analysis system 100 may be controlled by a proprietary operating system. Conventional operating systems control and schedule computer processes for execution, perform memory management, provide file system, networking, I/O services, and provide a user interface, such as a graphical user interface (“GUI”), among other things.

The sample loan tracking and analysis system 100 includes one or more commonly available input/output (I/O) devices and interfaces 110, such as a keyboard, mouse, touchpad, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. The loan tracking and analysis system 100 may also include one or more multimedia devices 140, such as speakers, video cards, graphics accelerators, and microphones, for example. In other embodiments, such as when the loan tracking and analysis system 100 comprises a network server, for example, the computing system may not include any of the above-noted man-machine I/O devices.

In the embodiment of FIG. 1, the I/O devices and interfaces 110 provide a communication interface to various external devices. In the embodiment of FIG. 1, the loan tracking and analysis system 100 is electronically coupled to a network 160, which comprises one or more of a LAN, WAN, or the Internet, for example, via a wired, wireless, or combination of wired and wireless, communication link 115. The network 160 facilitates communications between various computing devices and/or other electronic devices via wired or wireless communication links.

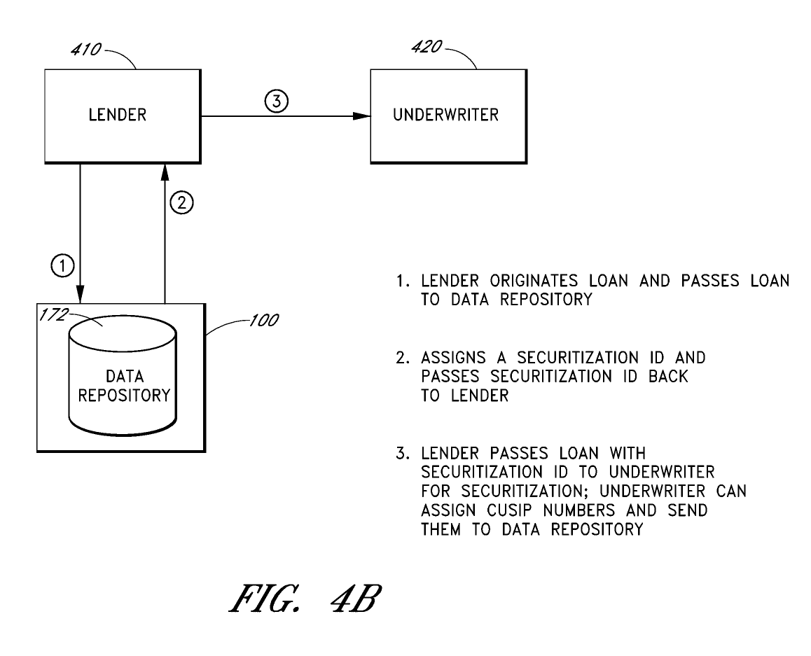

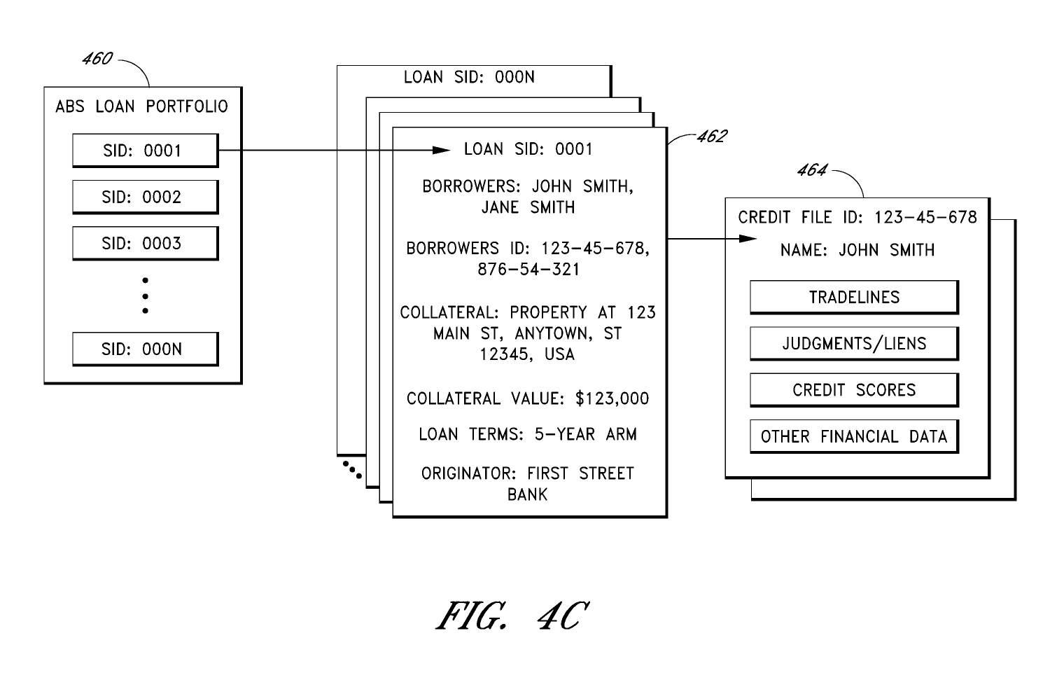

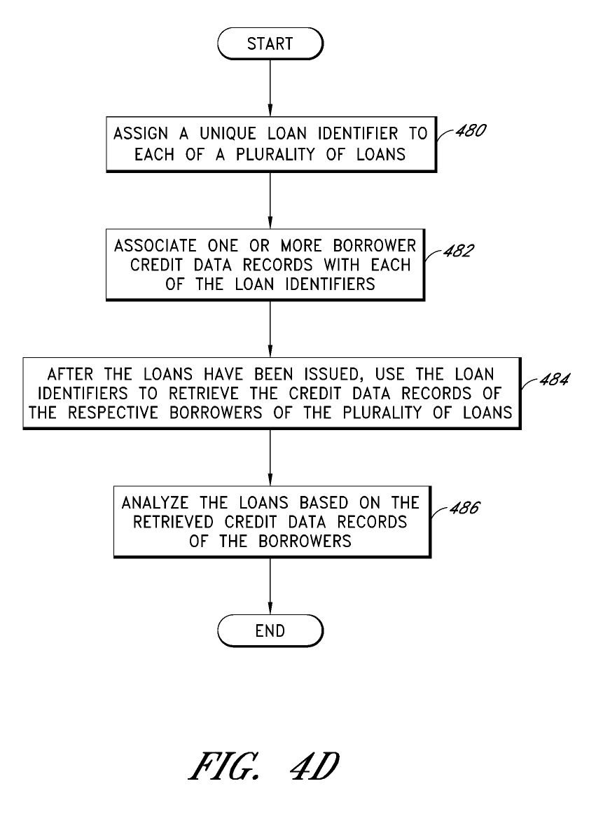

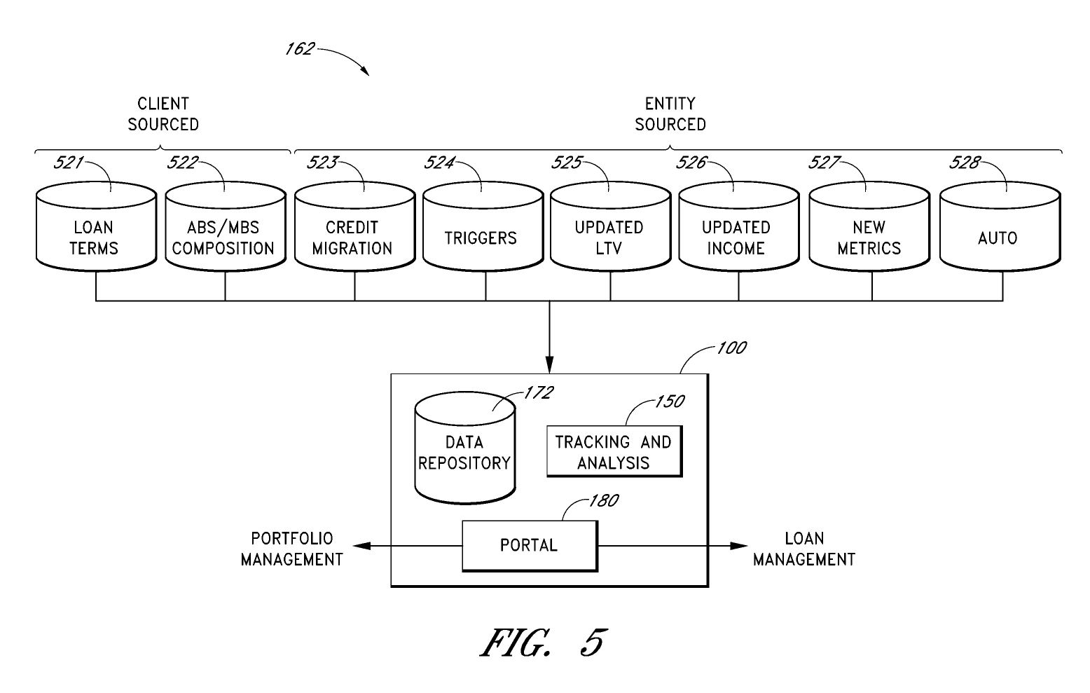

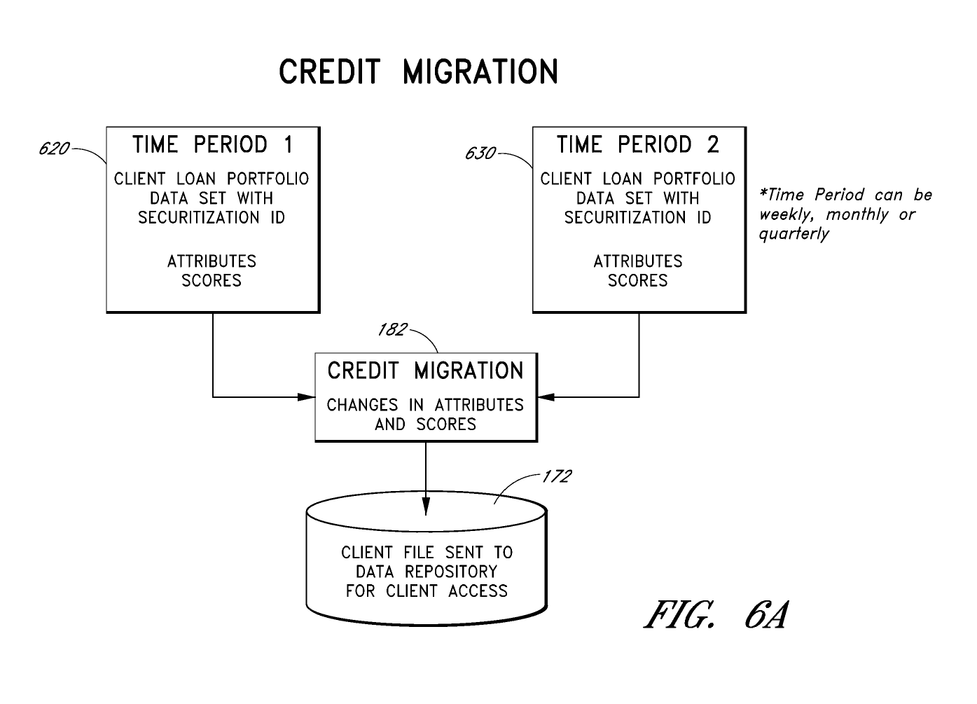

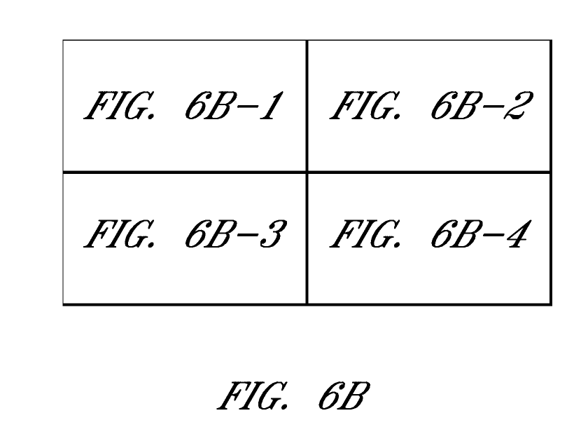

According to FIG. 1, information is provided to the loan tracking and analysis system 100 over the network 160 from one or more data sources including, for example, credit and/or loan information databases 162. The information supplied by the various data sources may include credit data, demographic data, loan data, loan application information, product terms, accounts receivable data, and financial statements, for example. In addition to the devices that are illustrated in FIG. 1, the loan tracking and analysis system 100 may communicate with other data sources or other computing devices. A number of these additional data sources are shown in FIGS. 4A, 5, 14, and 19, for example. In addition, the data sources may include one or more internal and/or external data sources. In one embodiment, the loan tracking and analysis system 100 includes a credit migration module 182 that retrieves credit data from at least one of the databases 162. In some embodiments, one or more of the databases, data repositories, or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

A client 164 may access the loan tracking and analysis system 100 through the network 160. The client 164 may include a desktop or laptop computer, a computer server, a mobile computing device, a Blackberry, or other similar electronic device. In addition to supplying data, client 164 may further request information including data and analytics from the loan tracking and analysis system 100. For example, the client 164 may request data related to a borrower or a group of borrowers, or data related to a loan or a group of loans. Such a request may include borrower/loan information identifying the borrower(s)/loan(s) for which information is desired.

In the embodiment of FIG. 1, the loan tracking and analysis system also comprises a data repository 172. In other embodiments, the system 100 communicates with the data repository 172 through a network, such as a LAN, WAN, or the Internet via a wired, wireless, or combination of wired and wireless, communication link. In certain embodiments, the client 164 may have access to the data repository 172 through the network 160, and/or other network.

In the embodiment of FIG. 1, the loan tracking and analysis system 100 also includes a tracking and analysis module 150 that may be executed by the CPU 105. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiment shown in FIG. 1, the loan tracking and analysis system 100 is configured to execute the tracking and analysis module 150, among others, in order to track and analyze loans involved in ABS by using data in the data repository 172, credit and/or loan information databases 162, and/or other data sources that comprises data regarding ABS, such as those shown in FIGS. 4A, 5, 14, and 19. These records may be accessed by the tracking and analysis module 150 to track and analyze loans, as will be described in more detail below. The loan tracking and analysis system 100 may also include a portal interface 180, which is configured to generate one or more graphical user interfaces (“GUIs”) through which loans can be tracked and analyzed. The portal interface 180 may provide access to loan analysis results and reports generated by the tracking and analysis module 150. Finally, the loan tracking and analysis system 100 may also include a trigger notification module 184, which sends notifications to users of the system when credit data sources associated with the loans involved in ABS meet certain user-defined condition triggers. In some embodiment, the trigger notification module may also compare calculated loan default risks to a set of pre-defined threshold conditions as part of a health check (on-going portfolio management), and send notifications when at least one of the threshold conditions is met.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage. In addition, all the methods described herein may be executed as instructions on the processor as shown in FIG. 1, and may result in the manipulation or transformation of data. Input data and output data may be accessed from or provided to the databases and/or mass storage device shown in FIG. 1.

Asset-Backed Securities (ABS) Tracking and Analysis

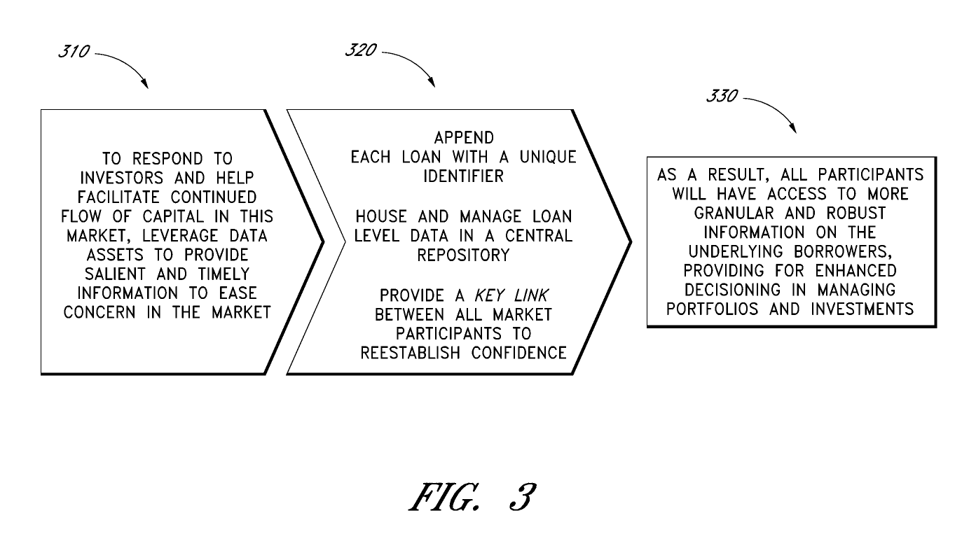

FIG. 2 provides an overview of the method and system in accordance with one embodiment. At block 210, loan issuers issue loans backed by a variety of assets including, for example, real estate and automobiles. The issuers then forward the loans to underwriters, Special Purpose Vehicles (SPV), or Trusts at block 220, and the underwriters bundle the loans into asset-backed securities (ABS). In the bundling process, the underwriters also evaluate the strength of the ABS, work with rating agencies to rate them, and associate them with various rates of return. The ABS are then presented to investors for investment at block 230.

In some embodiments, the loan tracking and analysis system 100 is configured to reduce problems in the way ABS are constructed and presented to investors. Often at block 230, investors do not know the current value of the ABS they are holding, and have no access to the credit profiles of the individual borrowers that underlie the securities. Sometimes the only piece of credit information available is a credit score obtained at the time of loan origination. Servicers are limited to the performance of the loan that they are serving and do not have access or insight into the comprehensive profile of the borrowers' credit behavior. Changes in borrower behavior and underlying assets are not captured over time.

The lack of transparency becomes exposed in actual market failures. As a result, investors may lose confidence in the rating and valuation generated by the underwriters at block 220. This may lead to a decreased level of investment, which in turns leads to decreased liquidity in the market. As shown in FIG. 2, decreased liquidity may lead to decreased loan origination volume at block 210. The decreased origination volume in turn may lead to decreased trading volume of ABS at block 220.

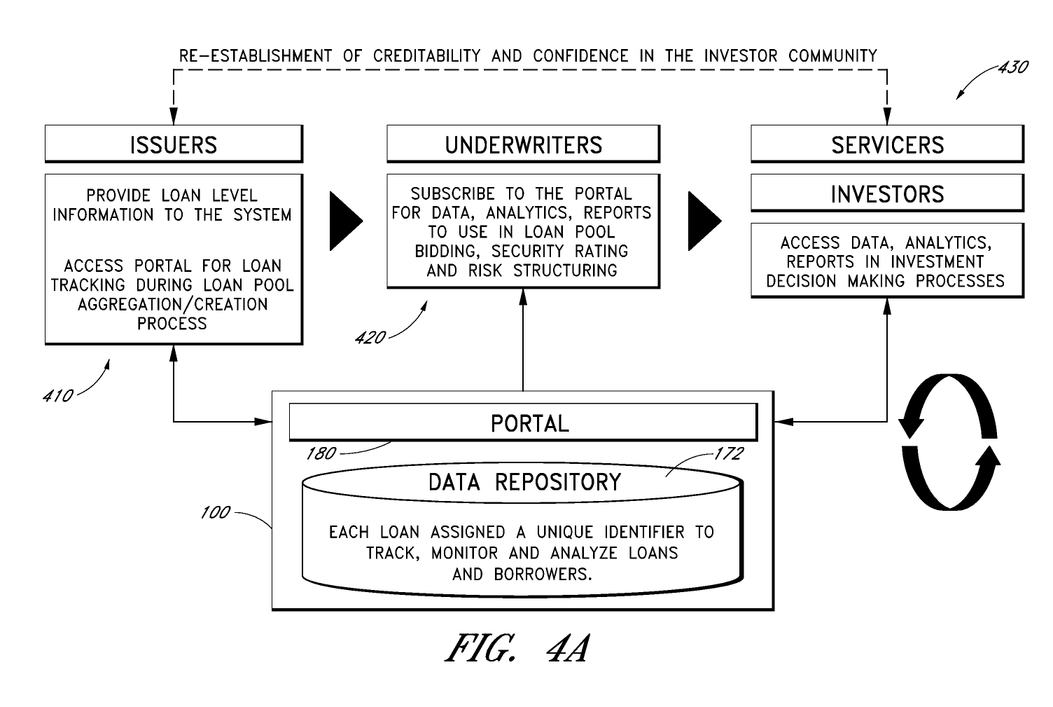

FIG. 3 provides an overview of a tracking method in accordance with one embodiment. In response to the loss of confidence in the ABS capital markets, embodiments of the systems and methods described herein are directed to increase transparency by providing a link among the market participants—loan originators/issuers, investment banks, trusts, servicers, and investors. To this end, in some embodiments the loan tracking and analysis system 100 appends unique loan identifiers to data records for individual loans, allowing the market participants to track each loan through its lifecycle, both at its origination (the primary market) and when it is later securitized and resold as part of an investment (the secondary market). In one embodiment, the loan tracking and analysis system 100 tracks, monitors, and analyzes each pool or portfolio of loans and hosts loan level data in the data repository 172. An example portfolio could be a service portfolio belonging to a loan servicer that services student or auto loans or an investment portfolio that belongs to an investment bank. In essence, the loan tracking and analysis system 100 may function as a credit file for the capital markets.

As shown in FIG. 3, the loan tracking and analysis system 100 may be configured to correct this loss of confidence and help facilitate the continued flow of capital into this market by leveraging available credit and financial data assets to provide salient and timely information to ease concern in the market (block 310). In certain embodiments, the loan tracking and analysis system 100 may append each loan record with a unique loan identifier, house and manage loan level data in a central data repository (for example, in the data repository 172), and through the use of unique loan identifiers, provide a key link between market participants involved in the ABS process (block 310). The loan record itself may additionally include any first, second, or other level related data to a subject loan or obligation, or the loan identifier may link these additional data to the loan record. These unique loan identifiers may be used to provide participants in the securitization market with additional information that may reestablish confidence in the ABS market. As a result, all participants may be provided access to more granular and robust information on the underlying assets, providing for enhanced decision-making in managing portfolios and investments (block 310).

Loan Tracking and Analysis Process and System

FIG. 4A is a diagram depicting a system and method in accordance with one embodiment. At block 410, an issuer provides loan data to the data repository 172 of the loan tracking and analysis system 100, and the system 100 appends a unique loan identifier, also referred to as a securitization ID in one embodiment, to the loan data and may return the unique loan identifier to the issuer. The unique identifier can include a social security ID number, a tracking number, a bar code or grid, and/or any other any alpha-numeric identifier. In one embodiment, the loan tracking and analysis system 100 may be operated by a credit bureau. Optionally, the unique loan identifier can be automatically appended to loan data when an issuer reports the loan to the loan tracking and analysis system 100. Once the unique loan identifier has been appended, the issuer or any other authorized party can access the portal interface 180 to track the loan's progress and/or report updates. In addition, the portal interface 180 can be used to track a plurality of loans during an aggregation process in which loans are grouped together for the purpose of securitization. In contrast to the internal loan tracking numbers assigned by the issuers that are not passed to underwriters and investors, the unique loan identifiers may be maintained throughout and/or beyond the life of the loans. The unique loan identifiers may enable underwriters, investors, and others, to access historical as well as updated loan data associated with specific loans, as well as credit and payment behavior data of borrowers associated with the loans. In other embodiments, other identifiers such as MIN (Mortgage Identification Number), ASF (American Securitization Forum) Loan ID, parcel number, VIN (Vehicle Identification Number), and other ID number may be used to track loans (e.g, identifiers assigned at the time of origination).

At block 420, underwriters can use the portal interface 180 to access loan data, analytics, and reports. Such information can be used in loan pool bidding, security rating, and risk structuring. Underwriters may also send loan identifiers and corresponding security identifiers, for example, CUSIP (Committee on Uniform Security Identification Procedures) numbers, to the loan tracking and analysis system 100 during the securitization process and the loan tracking and analysis system 100 may associate the loan identifiers with the proper security identifiers. At block 430, investors can also access data, analytics, and reports for all the loans in their ABS investments through the portal interface 180. This access to loan level data may enhance their investing decisions because investors can verify updated conditions of the underlying assets and financial conditions of the borrowers. Similarly, loan servicers may also access the same type of analytical data for loans in their service portfolios via the portal interface 180. For example, student loan servicers may access the credit scores of the students within their loan pools to better gauge default risks or anticipate losses. Market participants may also need to access such data and analytics in compliance with governmental regulations that mandate periodic financial disclosure and reporting. Portfolios may be accessed by supplying the loan tracking and analysis system 100 the CUSIP numbers. Other interested parties such as governmental regulatory bodies may access these loan data through the portal interface 180 as well. In other embodiments, other identifiers such as MIN (Mortgage Identification Number), ASF (American Securitization Forum) Loan ID, parcel number, VIN (Vehicle Identification Number), ISIN (International Securities Identification Number), deal name, and other ID number may be used to track and/or access corresponding loans or portfolios.

Generally speaking, a credit enhancement is a method to reduce risk by providing some insurance or guarantee agreements to reimburse investors in the event of a loss. Because the disclosed embodiments provide, through portal interface 180 or other output mechanisms, additional updated loan and borrower data, models, reports, and analytics to investors that were previously inaccessible, the disclosed embodiments also reduce risks of loss and thus can be used as credit enhancements to create a security that has a higher rating than the issuing company that monetizes its assets. This may allow the issuer to pay a lower rate of interest than would be possible via a secured bank loan or debt issuance.

Loan Identifier Assignment and Data Structure

FIG. 4B shows a loan identifier assignment method in accordance with one embodiment. In this embodiment, a lender 410 originates a loan and passes associated loan data to the loan tracking and analysis system 100. Then the loan tracking and analysis system 100 determines and assigns a securitization ID to the loan and passes the securitization ID back to the lender. The loan tracking and analysis system 100 may store the loan information along with the securitization ID so that other authorized market participants may access the loan information in the future with the securitization ID. Next, upon the issuance of the loan, the lender 410 passes the loan along with the securitization ID to the underwriter or Special Purpose Vehicle (SPY) 420 for securitization. Once the securitization process is completed, the Underwriter or SPV may send the CUSIP number for the newly created security to the loan tracking and analysis system 100. In one embodiment, the CUSIP numbers may be stored in the data repository 172 and may be used to retrieve corresponding credit and financial data for analyzing the performance of the securities.

FIG. 4C shows an example data structure in accordance with one embodiment. As shown, an example ABS loan portfolio 460 may bundle many loans. In accordance with the system and method depicted in FIG. 4A, each loan is associated with a unique identifier that is created and associated with the loan at the point when the loan is first issued (e.g., block 410 in FIG. 4A). In the embodiment shown, a Securitization ID (SID) is used as the unique identifier, and as shown, a SD 0001 is associated with a loan record 462 comprising data associated with a particular loan. In one embodiment, the loan record 462 may include various details associated with one or more loans, including the information on the borrowers and the collateral, loan terms, and other loan-related data.

In particular, the loan record 462 may include an identifier that identifies the borrowers of the loan. The loan record 462 may additionally include any first, second or other level relation data to a subject loan or obligation. The borrower identifier may include a social security number, a taxpayer ID number, an internal database linking identifier, and/or any other identifier that links the loan record to the borrower's financial data/credit data file. As shown in FIG. 4C, borrower credit data record 464 is linked to the SID 0001 by way of a borrower ID “123-45-678.” In one embodiment, the credit data record may be a unique PIN-based consumer credit data record. In other embodiments, other types of identifiers such as keys may be used. The borrower's credit data record 464 may contain tradelines, judgments and liens, credit scores, and other financial data regarding a particular individual, or group of related individuals. As such, a SID may be used to cross-reference one or more associated borrower identifiers and access the credit record(s)/file(s) of the borrower(s) of the loans underlying the ABS. Interested parties, such as ABS investors, may therefore assess and monitor factors that may affect the borrowers' ability to repay the loans. In other embodiments, loan records are not stored in the loan tracking and analysis system 100. Rather, the loan tracking and analysis system 100 stores a database table pairing unique loan identifiers with corresponding borrower identifiers. The pairing allows the borrowers' financial and credit data to be accessed by using the unique loan identifiers.

FIG. 4D shows a tracking and analysis method in accordance with one embodiment. At block 480, a unique loan identifier is assigned to each of a plurality of loans. Then at block 482, one or more borrower credit data records are associated with each of the loan identifiers. After the loans have been issued and securitized as asset-backed securities, possibly being transferred between multiple portfolios, at block 484 the loan identifiers are used to retrieve the credit data records of the respective borrowers of the plurality of loans. The loans may be assigned to loan portfolios and each portfolio may be assigned a security number (for example, a CUSP number). Thus, the loan tracking and analysis system 100 may be able to access the credit data records by cross-referencing the loan identifiers associated with a security number. For example, the loan tracking and analysis system 100 may be able to retrieve credit data records for borrowers of a loan portfolio given the portfolio's CUSIP number. Finally, at block 486, loan details may be analyzed based on the retrieved credit data records of the borrowers.

Data Sources for ABS Analysis

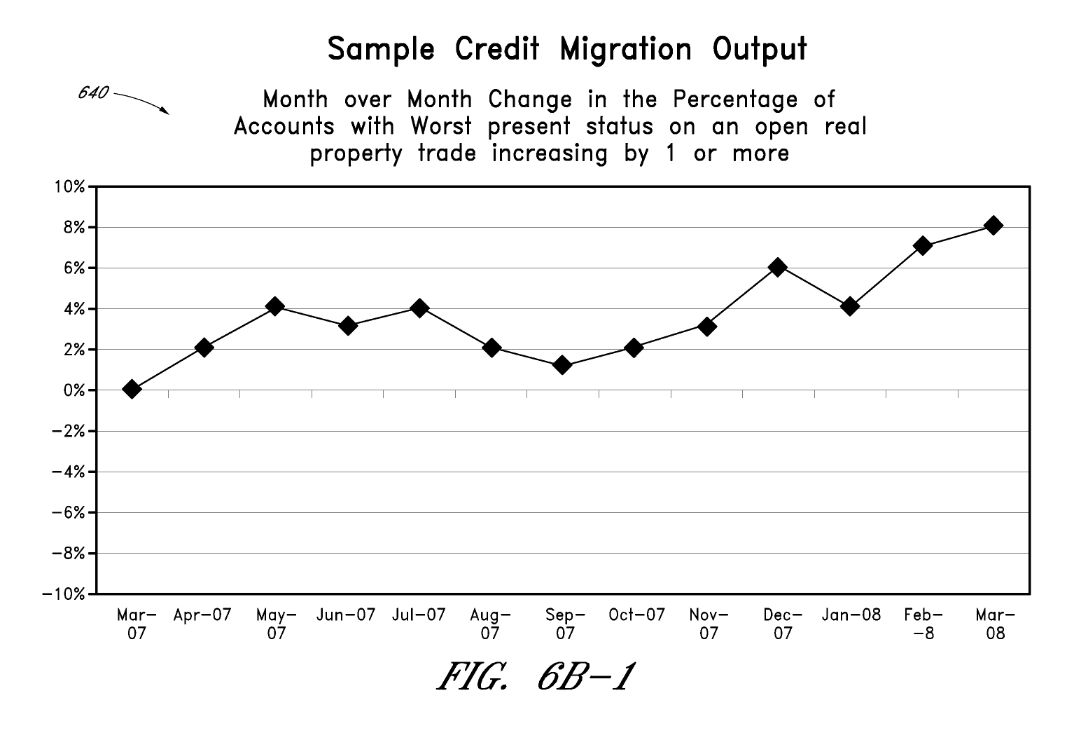

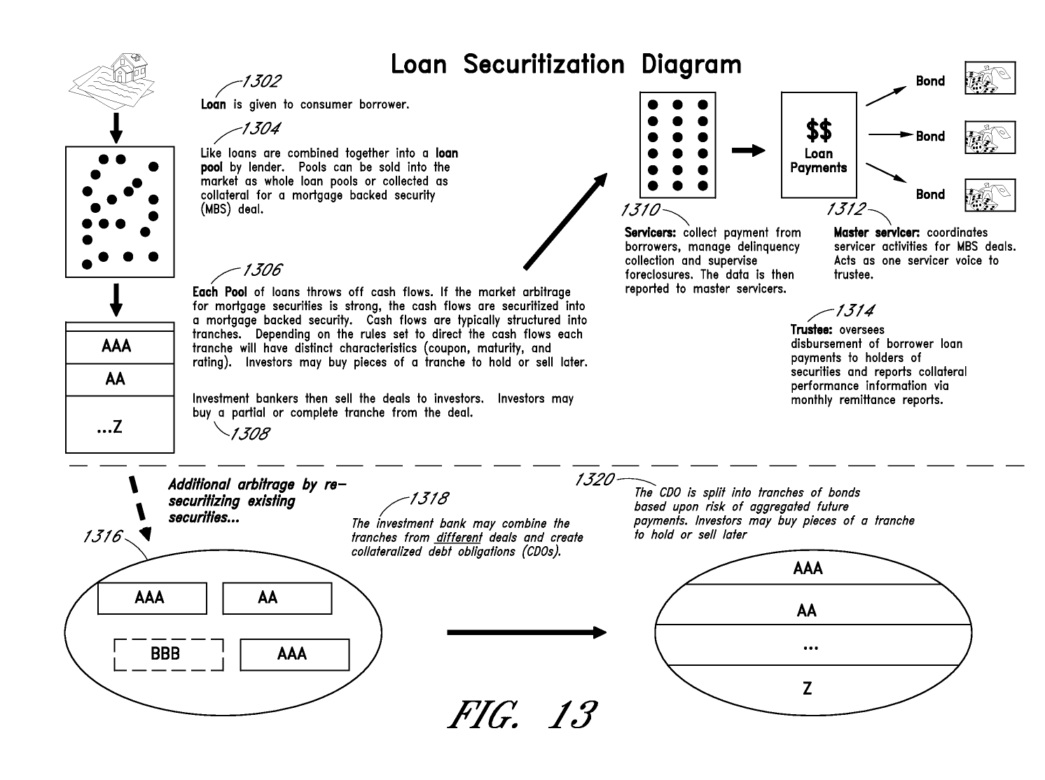

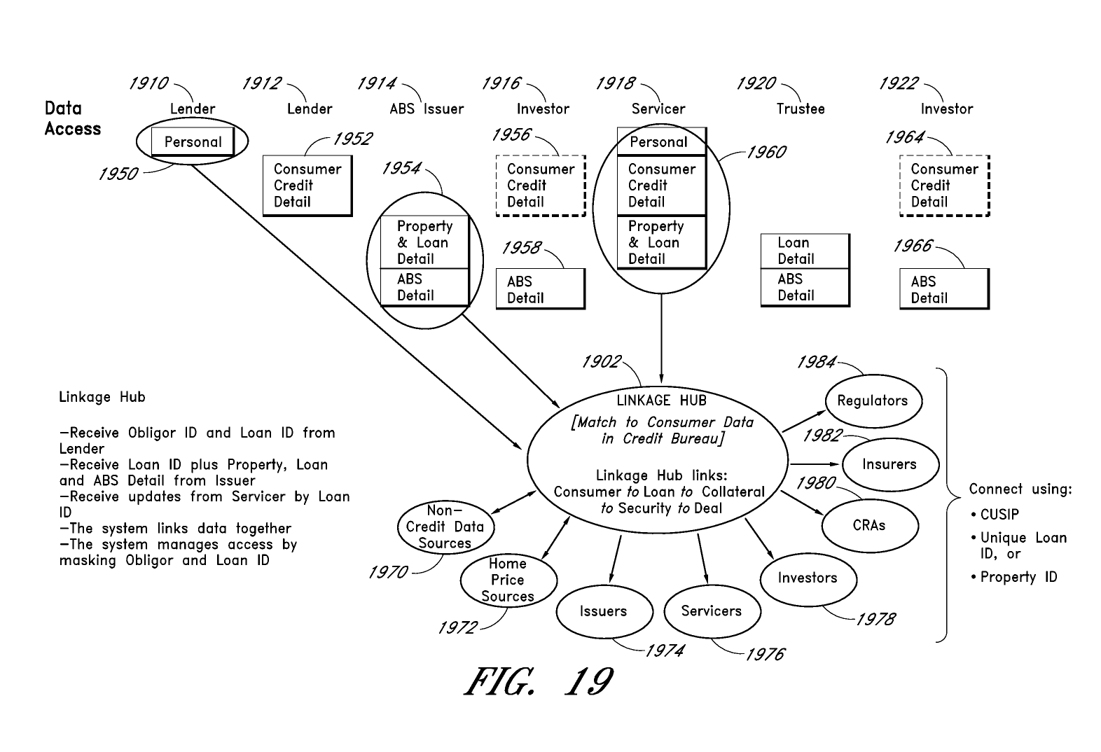

FIG. 5 depicts one embodiment of the system 100 in communication with a plurality of credit and/or loan information databases 162, specifically noted in FIG. 5 as data sources 521-528. The loan tracking and analysis system 100 as illustrated in FIG. 5 includes only a few of the modules that are available in embodiments of the system 100 (see FIG. 1, for example). In particular, the system 100 of FIG. 5 includes the tracking and analysis module 150, the portal interface 180, and the data repository 172, which may include data from a variety of data sources. In one embodiment, data is sourced from a loan terms database 521 and/or an ABS/MBS composition database 522. These two databases may reside at the issuer, the underwriter, or elsewhere. Data may also be sourced from a credit migration database 523, a triggers database 524, an updated Loan to Value (LTV) database 525, an updated income database 526, a new metrics database 527, an auto loan data database 528, and any number of additional credit or non-credit data sources, as illustrated in FIGS. 14 and 19.

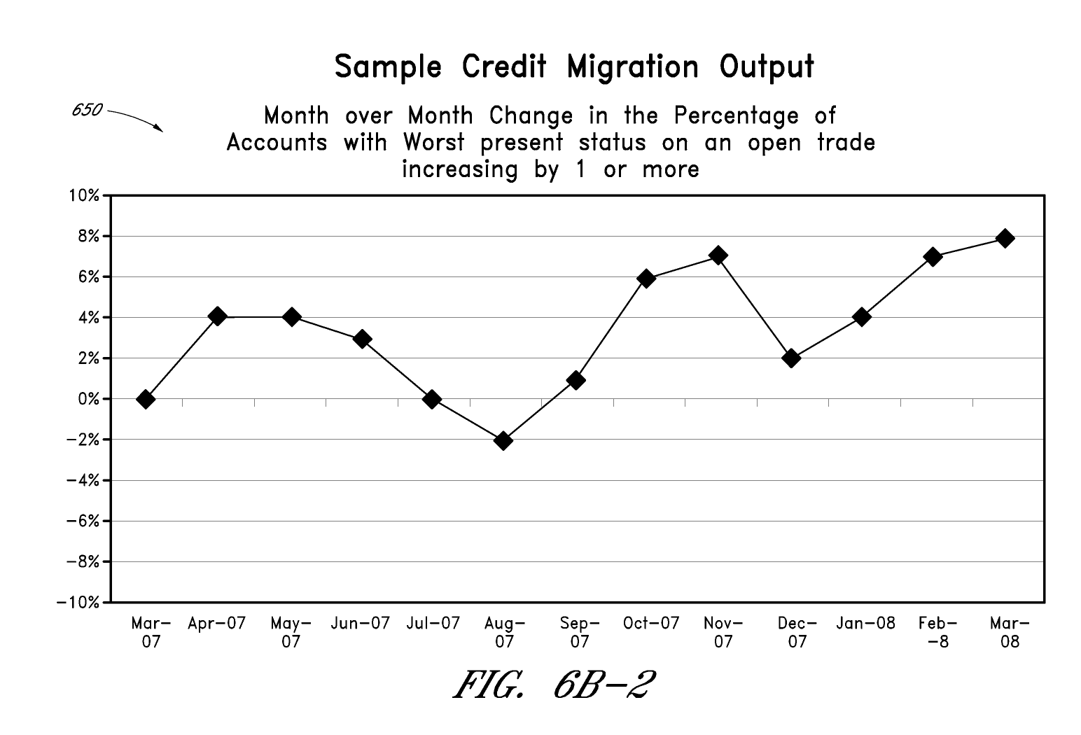

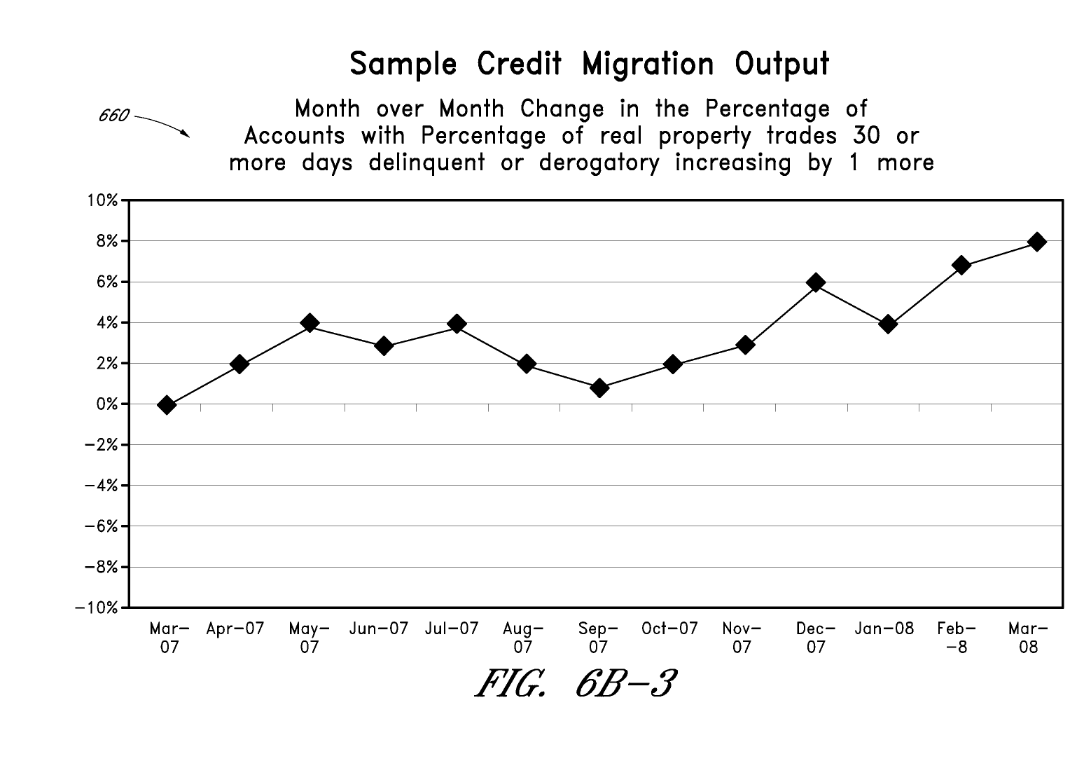

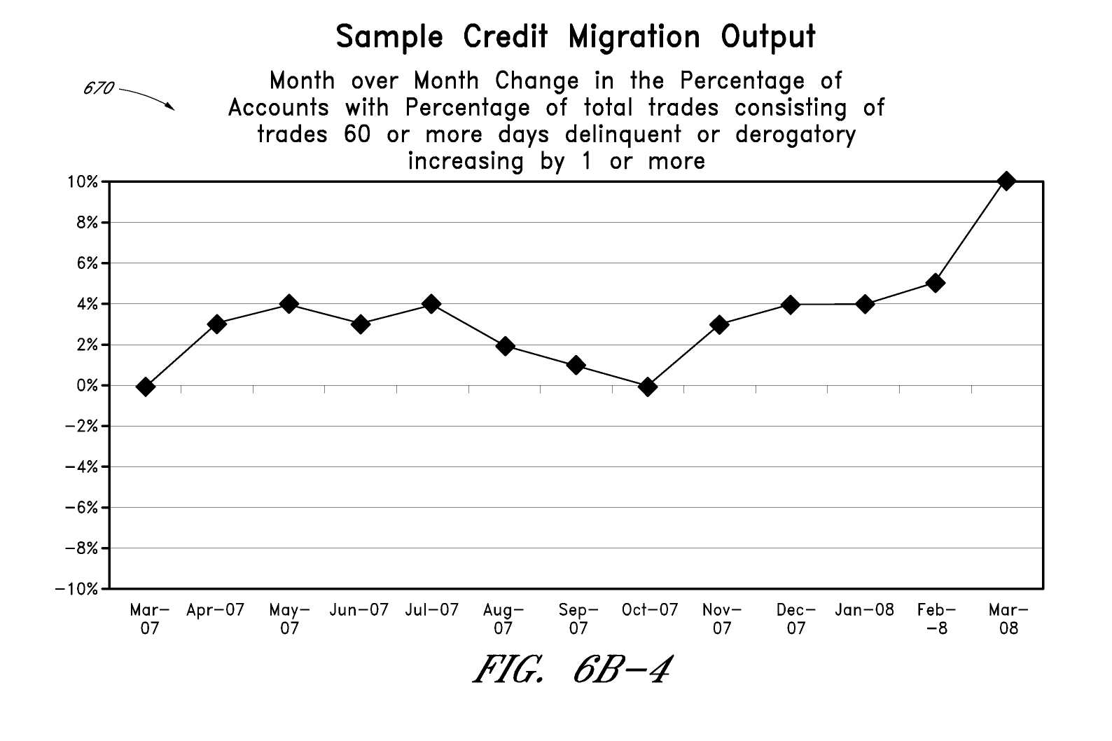

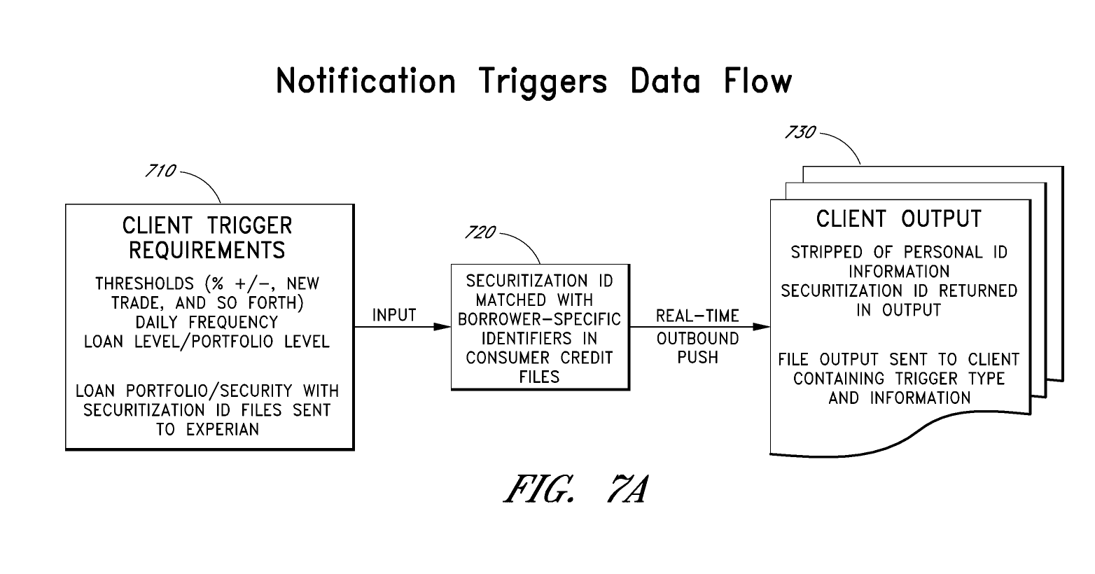

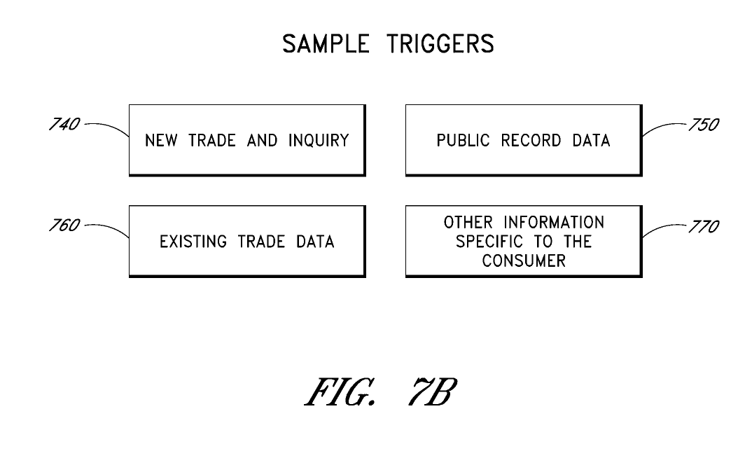

The credit migration database 523 may provide the loan borrowers' credit data and credit histories. The credit migration database 523 and its use will be further described in conjunction with FIGS. 6A and 6B. The triggers database 524 may provide pre-defined conditions that may trigger alerts to the users if those conditions are met. Likewise, the triggers database 524 and its use will be further described in conjunction with FIGS. 7A and 7B.

The updated LTV database 525 may store continuously or periodically updated information on loan values, underlying asset values, and the ratios of loan values to asset values. In one embodiment, the asset valuation information may be obtained from a source outside of the entity hosting the loan tracking and analysis system 100. The updated income database 526 may provide updated data on the borrowers' current income. The income information may be obtained from an outside source or may be estimated based on data collected by the hosting entity. The new metrics database 526 may provide additional metrics, such as custom-defined credit attributes and credit scores, that may aid in the analysis of the ABS. The new metrics database 526 may include, for example, special monitoring conditions or analytic instructions submitted by investors or loan servicers that are particular to their ABS or loan portfolios. Finally, the auto loan database 528 may include additional loan details related to automobile loans. These six databases may reside within the same entity that is hosting the loan tracking and analysis system 100. Those skilled in the art will recognize that these databases can be combined into fewer databases, or may be implemented as parts of a single database. Conversely, they may be divided into a greater number of databases. Finally, these databases as shown may be implemented as a combination of parts within the same databases and separate databases.

The loan tracking and analysis system 100 may further include the tracking and analysis module 150 for processing data and outputting results. In one embodiment, the results of the analysis are accessible via the portal interface 180. The portal interface 180 may be configured to accept requests from a variety of devices, including but not limited to computer servers, personal computers, laptop computers, kiosks, and mobile devices such as phones, PDAs, and Blackberries, and output results in one or more GUIs to those devices.

Two mechanisms by which the loan tracking and analysis system 100 retrieves and analyzes loan data—credit migration and triggers—will be further described below.

Credit Migration

One problem ABS investors face is the inability to retrieve up-to-date analysis of the loans underlying the ABS. Often ABS issuers provide only analysis obtained at the point of loan origination or ABS generation but little else after the sale of the ABS. The credit migration mechanism in one embodiment addresses this need and provides up-to-date analysis to investors and other market participants.

FIG. 6A shows the credit migration module 182 of the system 100 (FIG. 1) that periodically retrieves data for a plurality of client loan portfolio data sets with their associated securitization IDs. The client here may be, for example, an investment bank that wishes to monitor the performance of a particular investment portfolio, a loan servicer that wishes to monitor the creditworthiness of the borrowers that are in its loan service portfolio, or any other interested party. These clients may send to the loan tracking and analysis system 100 information regarding loan portfolios, including the associated securitization IDs. Alternatively, the loan tracking and analysis system 100 may keep track of the loans that are associated with each client's portfolio(s).

In one embodiment, the credit migration module 182 is configured to retrieve, at specified time intervals, credit attributes, scores, and other credit-related data of the borrowers of the loans referenced by the securitization IDs. In one embodiment, the credit data is retrieved in accordance with the lookup and cross-referencing method depicted in FIG. 4C. In the example shown, a data set 620 from a time period 1 and a data 630 set from a time period 2 are retrieved by the credit migration module 182 for comparison. The time period can be weekly, monthly, quarterly, or any other frequency. In one embodiment, the credit migration module 182 migrates the necessary data from a credit database into the data repository 172 of the loan tracking and analysis system 100 at specified time intervals. Co-pending U.S. patent application Ser. No. 11/973,300, filed Oct. 5, 2007, entitled “System and Method for Generating a Finance Attribute From Tradeline Data,” the disclosure of which is hereby entirely incorporated by reference, further describes various embodiments of credit data attributes. The credit data attributes may include collateral value attributes in one embodiment.

Once the credit data are retrieved, the credit migration module 182 and/or the tracking and analysis module 150 calculates or determines changes in attributes, scores or other credit data. For example, the credit migration module 182 and/or the tracking and analysis module 150 may calculate the change in average credit scores of the borrowers in the portfolio data set, determine whether these borrowers have opened new lines of credit, or determine whether negative credit items have been added to their credit files, and so forth. These changes and/or the retrieved credit data may then be migrated to the data repository 172. Over time, the data repository 172 may accumulate a history of the credit and analysis data, such as over the life of the ABS loan portfolios, and can output these historical data.

FIG. 6B shows four sample outputs, such as graphical user interfaces that are displayed on a computer monitor or in printed form, of the credit migration module in accordance with one embodiment. These outputs may be in a raw data format, a table/spreadsheet format, or in a graph format as shown and they may depict historical trends or comparison of data obtained from different specified intervals. The trends may include payment behavioral changes, credit behavioral changes, and projection of future performances.

FIG. 6B-1 shows an example output graph 640, which plots monthly changes in the percentage of loan accounts in a portfolio having a worst present status on an open real property trade increasing by 1 or more. In general, a worst present status in an individual's credit history indicates a negative status on a tradeline account. In one embodiment, an increase in the number of worst present statuses on open real property trades (for example, mortgage) could be indicative of an increased default risk, and tracking this attribute over time can reveal the default risk associated with a loan portfolio. To illustrate this attribute, take for example a borrower A whose credit file lists multiple accounts such as credit cards, student loans, car loans, and several mortgages including home equity lines of credit. In the embodiment of FIG. 6B-1, a worst present status attribute that indicates whether borrower A has incurred a new worst present status in any of his mortgages (open real property tradelines) over the last month (that is, increasing by 1 or more) is shown. Therefore, if borrower A incurs a new worst present status in his mortgage No. 1 in April, another worst present status in his mortgage No. 2 in May, borrower A would have the attribute for both April and May. However, borrower A would not have the attribute in June if he does not incur any new worst present status, even though he already has two from the previous two months. Thus, the attribute can be thought of as tracking current negative credit history movements rather than the cumulative and/or historical negative credit histories of the borrowers in the loan portfolio.

Returning to the graph 640, the X-axis depicts the time intervals at which the credit migration module 182 retrieved credit data for this sample portfolio. The Y-axis depicts the percentage of loans in the sample portfolio that have the worst present status attribute. Graph 640 tracks the percentage of loans borrowers who have incurred at least one such worst present status in their open property trades within the last month. As shown in graph 640, the percentage of loans meeting this worst present status attribute increased from 0% to 8% over a period of one year. In one embodiment, the output graph 640 may provide investors of this portfolio the increased transparency that is lacking in the current market and an opportunity to evaluate the risks and make appropriate investment decisions. The output graph 640 can be an index that provides the market a way to properly valuate ABS in an on-going basis. For example, a credit rating agency may downgrade this sample portfolio upon seeing that the percentage of loans with the worst present status has increased to 8%.

Embodiments of the credit migration module 182 (FIG. 6A) may also analyze other credit attributes that may have correlations to default risks and provide output results of tracking these credit attributes. Similar to graph 640, graph 650 in FIG. 6B-2 also tracks monthly changes in the percentage of accounts with an increase of 1 or more in the worst present status, except graph 650 tracks such a status on any open trade line instead or an open real property line. Returning to the example of borrower A, this attribute in FIG. 6B-2 would track, in addition to new worst present status in borrower A's mortgages, such status in other non-real property related accounts in borrower A's file including credit cards, student loans, and auto loans. Again, the graph 650 shows a portfolio with a relatively steady increase in the percentage of worst present status increases and allows investors and other ABS market participants to take appropriate measures to counteract the increased risks.

Graph 660 of FIG. 6B-3 and graph 670 of FIG. 6B-4 plot monthly changes in the percentage of accounts that have real property trades that are delinquent or derogatory increasing by 1 or more. Graph 660 tracks the increase of 30-day delinquencies while graph 670 tracks the increase of 60-day delinquencies. Returning to the example of borrower A, these attributes would track delinquencies within borrower A's credit files. For example, if borrower A is more than 30 days late in his mortgage payment, borrower A would be associated with the attribute tracked in graph 660. If borrower A is more than 60 days late in his mortgage payment, borrower A would be associated with the attribute tracked in graph 670. These attributes in the credit files have strong correlation to risk of loan defaults. Similar to graphs 640 and 650, these graphs show the historical progression of the monthly credit data migrations and may allow investors and market participants to view risk trends and decide on proper courses of action. In other embodiments, the credit migration module 182 may produce other analytical graphs tracking change of status in the tradelines such as degree of delinquency, life events, and so forth.

Triggers

In general, triggers are conditions that, when met, will initiate one or more system actions. Within the context of various embodiments, because each loan is trackable by a unique loan identifier, information on the borrowers can be obtained and correlated back to the individual loans. Thus, investors can set up triggers based on changes to the respective borrowers' credit files. In one embodiment, the trigger notification module 184 accepts as input several triggers that will generate alerts. For example, predefined alerts can be set up to notify investors, underwriters, and/or others, of the changes in underlying asset borrower behavior over time. An example trigger may send an alert if a certain number of borrowers in a loan portfolio have defaulted on their credit cards. The alerts can be sent at any time interval, for example, daily, weekly, monthly, quarterly, and/or in real-time. Depending on the embodiment, alerts may be sent via real-time email, periodic batch emails, real-time or periodic batch database exports. The alerts may be sent to computer servers, desktops, mobile devices, and may be sent via proprietary portal interface software, and so forth.

FIG. 7A shows a process of notification triggers data flow of the trigger notification module 184 (FIG. 1) in one embodiment. At block 710, a number of trigger requirements are defined by, for example, users of the loan tracking and analysis system 100 and sent to the system 100. The trigger requirements may include three primary components: thresholds, frequency of notification, and level of analysis (loan-level or portfolio-level). In other embodiments, the trigger requirements may be based on other attributes of loans, portfolios, and/or other related data. In addition, loan portfolio CUSIP numbers or securities with securitization IDs may also be sent to the loan tracking and analysis system 100 at block 710.

Thresholds are defined boundaries and may include credit score changes, number of new trades, and number of new accounts, and so forth. For portfolio-level triggers, thresholds can include the percentage of loans that must meet the thresholds before notifications are sent. Thresholds may be combined, for example, by Boolean operators. For example, an investor may define a trigger to include a 5% credit score change threshold and a 1 new account threshold for 10% of a portfolio. Thus when borrowers of at least 10% of the loans in the portfolio have both incurred a 5% change in their credit scores and opened a new account, the investor will be notified.

Once the triggers are defined, at block 720, the securitization IDs received in the input at block 710 are matched with the borrower-specific identifiers in the consumer credit files. In one embodiment the borrower-specific identifiers are the credit file IDs of the borrowers. At the pre-defined intervals in accordance with the frequency of notification input at block 710, the tracking and analysis module 150 checks the referenced credit files to see if data associated with the borrowers and/or portfolios still satisfy the trigger thresholds. If so, the trigger notification module 184 will send out notifications. In one embodiment, an output is sent at block 730 to the client users without any personal identifying information. The output may include securitization IDs in the portfolio that meet the trigger thresholds.

FIG. 7B shows four example data sources on which trigger sources may be based, such as new trade and inquiry triggers 740, public record data triggers 750, existing trade data triggers 760, and triggers based other information specific to the borrower 770. Thus, for example, an investor can set up a trigger to send an alert notification when a certain number of loan borrowers in their portfolios have new trades added to their credit files. Similarly, another investor may want to monitor whether a substantial number of judgments or liens from public record sources have been placed in the credit files of the borrowers in a portfolio. Thus, the collection of alert notifications may form a part of a holistic risk profile for a proactive approach to investment management.

Portal Interface

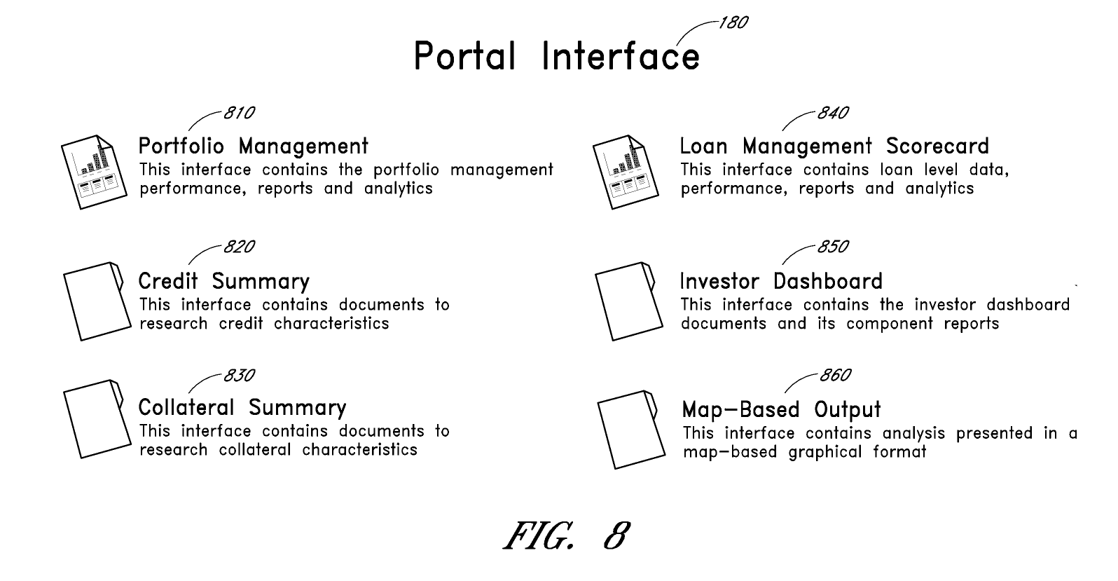

FIG. 8 shows a sample layout of the portal interface 180 (FIG. 5) in accordance with an embodiment. In one embodiment, the tracking and analysis module 150 and/or portal interface 180 may perform analysis on loan portfolios and output the results in a number of graphical formats. The portal interface 180 may be accessible via a web browser or standalone software application, for example. In the embodiment of FIG. 8, the portal interface 180 provides links to a plurality of interfaces, namely, a portfolio management interface 810, a credit summary interface 820, a collateral summary interface 830, a loan management scorecard interface 840, an investor dashboard interface 850, and a map-based output 860. The credit summary interface 820 may compute and/or show both current and historical credit histories of the individual borrowers, in either individual or aggregate formats. The collateral summary interface 830 may compute and/or show valuation and other data related to the collaterals (e.g. houses, cars) that underlie the loans. The portfolio management interface 810, the loan management scorecard interface 840, the investor dashboard interface 850, and the map-based output 860 will be described in greater details below.

Portfolio Management

As shown previously in FIG. 5, portal interface 180 can accommodate the display of analytics both at the loan portfolio level and at the loan level. In one embodiment, the portfolio level analytics are shown in the portfolio management interface 810, which provides a benchmark tool interface with trade level information for comparing the health of an ABS portfolio against peers, industry-wide averages, and/or historical performances. Because each loan is identifiable by a unique loan identifier, a variety of credit, financial, and loan data can be correlated to the individual loans. As a result, these data can be analyzed to more accurately reflect the health of the portfolio.

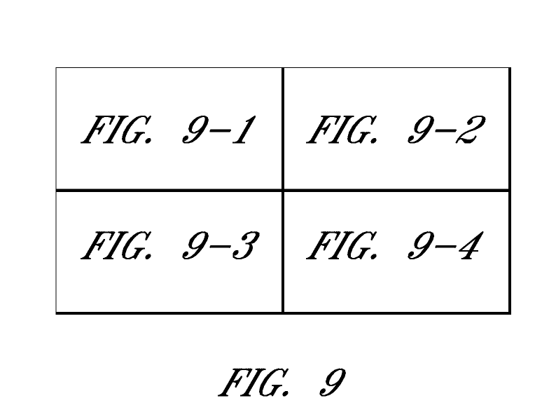

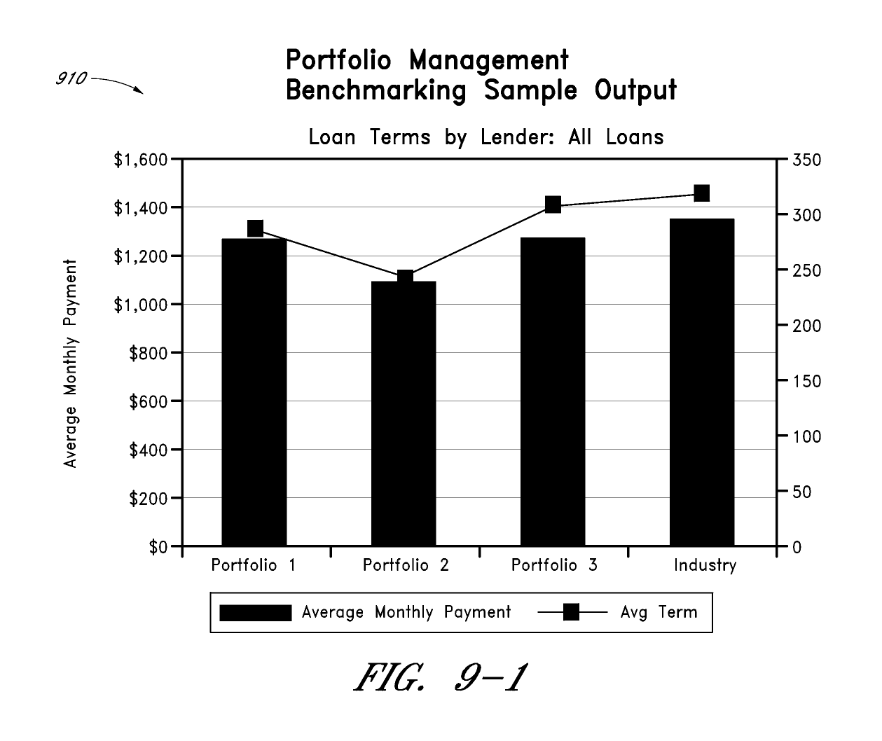

FIG. 9 shows the sample output graphs of the benchmarking tool interface. In this embodiment, sample graph 910 illustrates the loan terms and average monthly payment across several portfolios. Graph 920 is an example of the trending analysis that the benchmarking tool interface may perform in accordance to various embodiments. Because individual loans can be tracked throughout their life cycle, current data can be analyzed and compared to historical trends, industry trends, and projected future performance. Graph 920 shows loan delinquency trends plotted across three sample portfolios and against the industry average. Graph 930 shows the debt saturation level of several portfolios as compared to the industry average. Finally, graph 940 shows the risk distribution across the same three portfolios and the industry average. Depending on the embodiment, additional or fewer graphs may be available, and the information provided in the graphs may be different. For example, other graphs may compare loan portfolios against each other, against peer groups, against an industry average, and/or against a benchmark.

Loan Management

At the loan level, one embodiment of the loan tracking and analysis module 150 (FIG. 1) generates the loan management scorecard user interface 840, which provides transparency to the underlying assets of the ABS. The scorecard interface 840 may include reporting functionality to create customized charts and graphs and loan level detail drill down capabilities. The loan level detail may provide access to several key pieces of information, such as (1) Credit behavioral characteristics—historical, current, and projected; (2) Payment behavior; (3) Number of open accounts and balance; (4) Public Records; (5) Predictive behavioral scores for default and prepayment; (6) Refreshed Loan to Value Ratio; (7) Fraud score; and/or (8) Collateral Information.

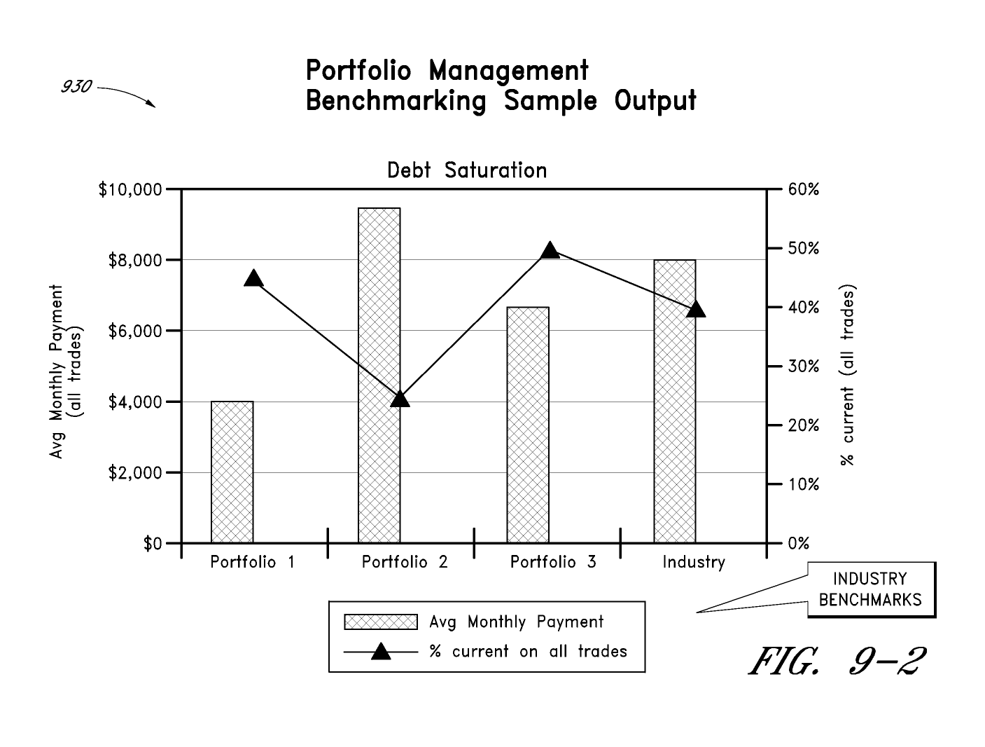

FIG. 10 provides a sample loan-level interface 1000. As shown, the sample loan-level interface 1000 provides part or all of the following information for each loan: origination date, original loan amount, current balance, loan type, original amortization term, remaining amortization term, original FICO, delinquency status, property type, ownership, and LTV. In addition, because data records for each loan are appended with a unique loan identifier, the loan-level interface 1000 may provide information pulled from other resources and correlated with the particular loan. For example, the loan-level view 1000 may further include account status information 1010 retrieved from the borrower's credit files, including the borrower's installment accounts, revolving accounts, auto loans/collateral, and student loans. Furthermore, the loan-level interface 1000 may additionally include information regarding public records and collection tradelines 1020 in the borrower's credit histories. In one embodiment, the loan-level interface 1000 may include a variety of updated scores 1030, including an updated credit score from a credit bureau, a refreshed FICO score by Fair Isaac, and/or a refreshed LTV, for example. Other computed scores 1040 including a default score, a bankruptcy score, a fraud score and/or a prepayment score, for example, may also be available.

Investment Dashboard

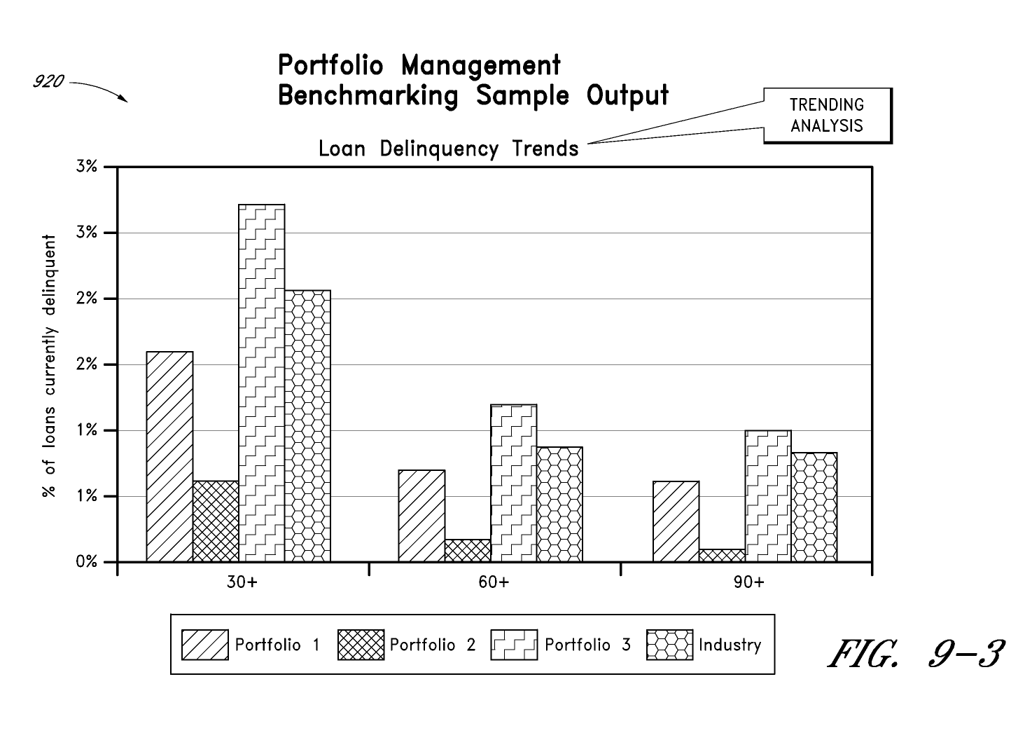

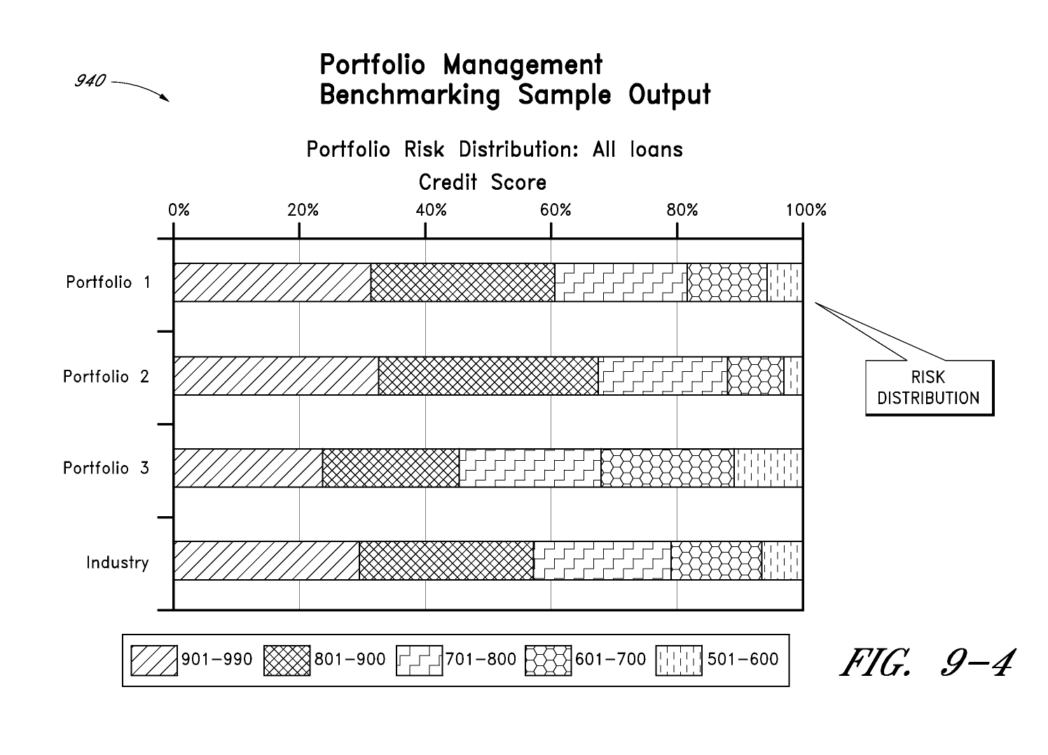

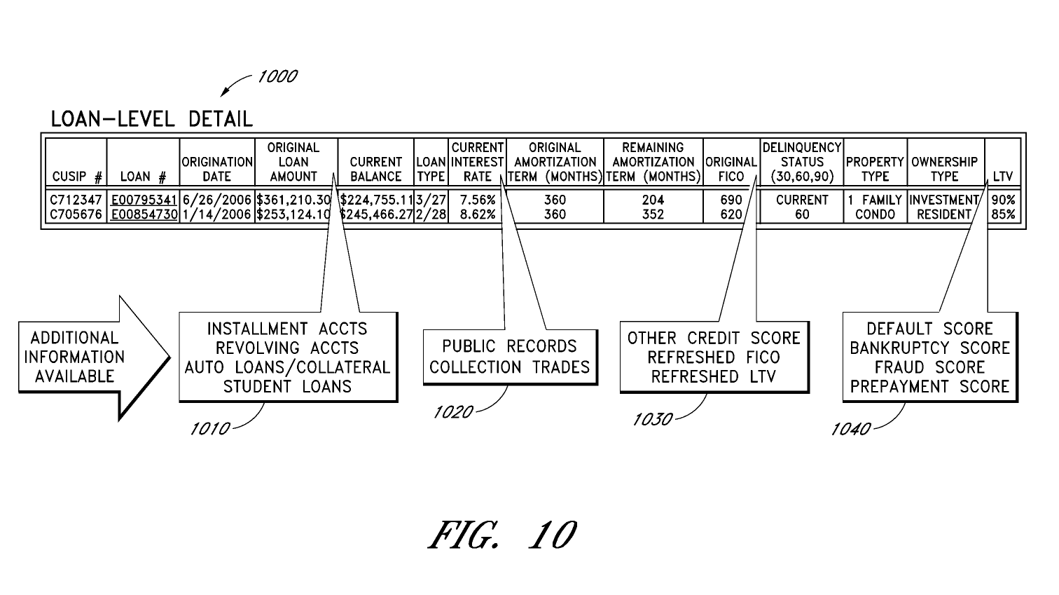

FIG. 11 shows a sample dashboard user interface, referred to herein as an investment dashboard 1100, in accordance with one embodiment. The dashboard 1100 offers investors (or other users of the system) a comprehensive view of the analytics of their portfolios over a given time period. As shown, the sample dashboard 1100 includes portfolio statistics such as volume, loan characteristics, delinquencies, cure rates, roll rates, and value declines and severities. In addition, the dashboard 1100 may provide refreshed risk scores, for example, credit scores and a new risk score from a credit bureau. The credit scores can be, for example, FICO scores by Fair Isaac, VantageScore by Experian, or other credit scores. The scores may be used to categorize loans into different risk segments. The dashboard 1100 may additionally provides payment behavior information, delinquency scores, debt saturation information, bankruptcy prediction, and/or collateral value information. The dashboard 1100 reports can be manipulated for time period analysis. In addition, the dashboard 1100 may include cross tab and additional drill down capabilities. For example, a 60-day delinquencies cross-tab may include a link to a page that shows detailed data related to loans that fall within the 60-day delinquent category. In one embodiment, the link may be accessed by clicking on the corresponding row of data display, for example, the label “60” under the “Delinquencies (by Active Loan Balance)” section. The linked cross-tab page may provide, for example, credit scores of borrowers whose loans are 60-day delinquent. In another example, the dashboard 1100 further provides a drill-down capacity that may allow users to further examine detailed loan-level data behind the numbers shown in the dashboard 1100. For example, investors can drill down to loan-level information for the loans that are 60-day delinquent from the dashboard 1100.

Map-Based Portfolio Analysis

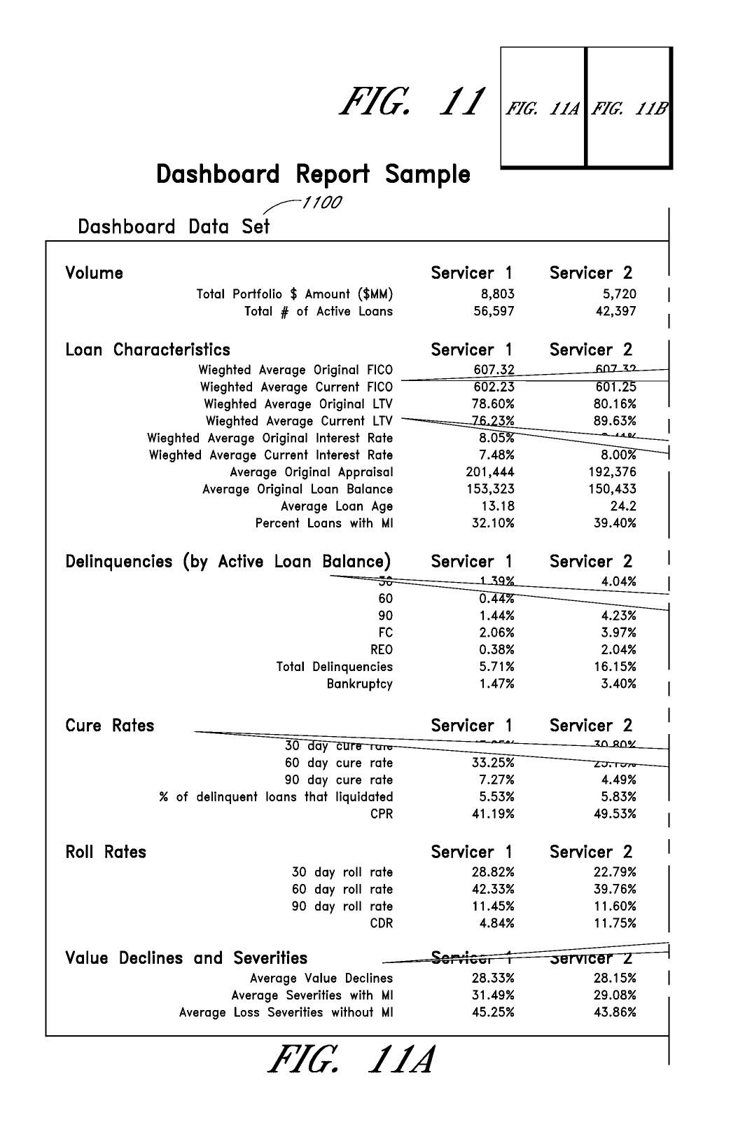

FIG. 12 shows a map-based portfolio analysis in accordance with one embodiment. As shown, at block 1210 loan portfolios and ABS that have been associated with SIDs and/or CUSIPs are input into the loan tracking and analysis system 100. At block 1220, addresses of the borrowers and/or collaterals are then located by cross-reference in the repository 172, for example, by the method shown in FIG. 4C. At block 1230, the addresses are then joined with a location based data source. In the example shown, the addresses are joined with the ZIP+4 (9-digit ZIP) data source, which summarizes the credit data for populations in the United States. The credit data may include credit data, financial data, summarized credit statistics, and/or collateral information. Other data sources such as 3-digit ZIP, 5-digit ZIP, and 7-digit ZIP can be used as well. The results are provided in a map interface 1240, which displays the geographic allocation of the collaterals or borrowers within a portfolio, along with a color coded-scheme for representing the credit summary used. The map-based view offers investors (or other users of the system) a geographic view of the analytics of their portfolios.

### Additional Embodiments

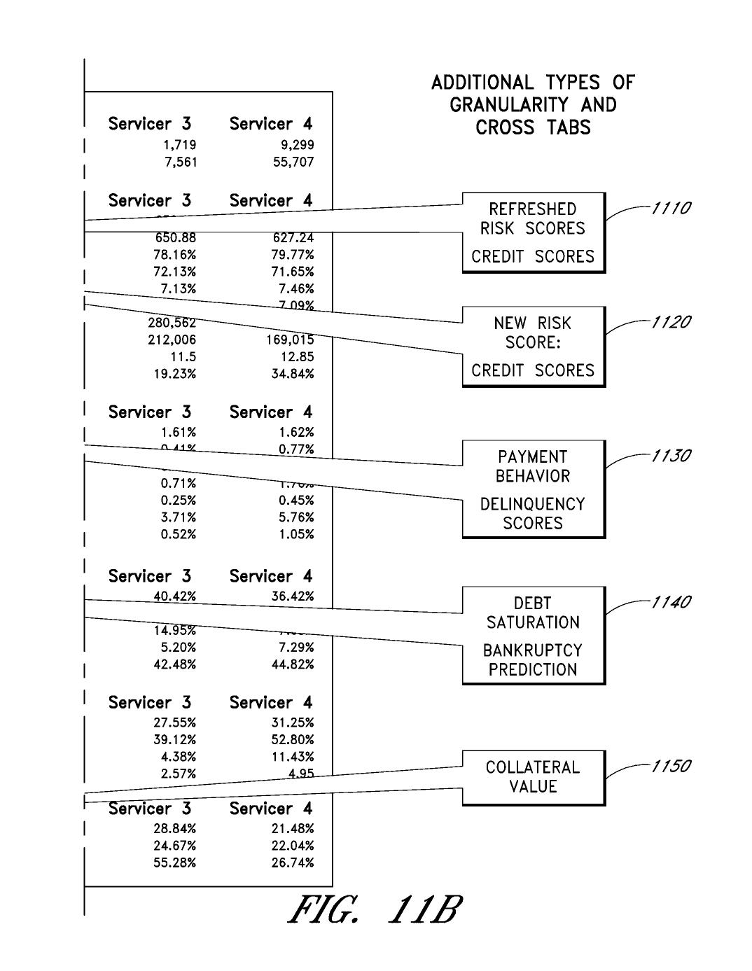

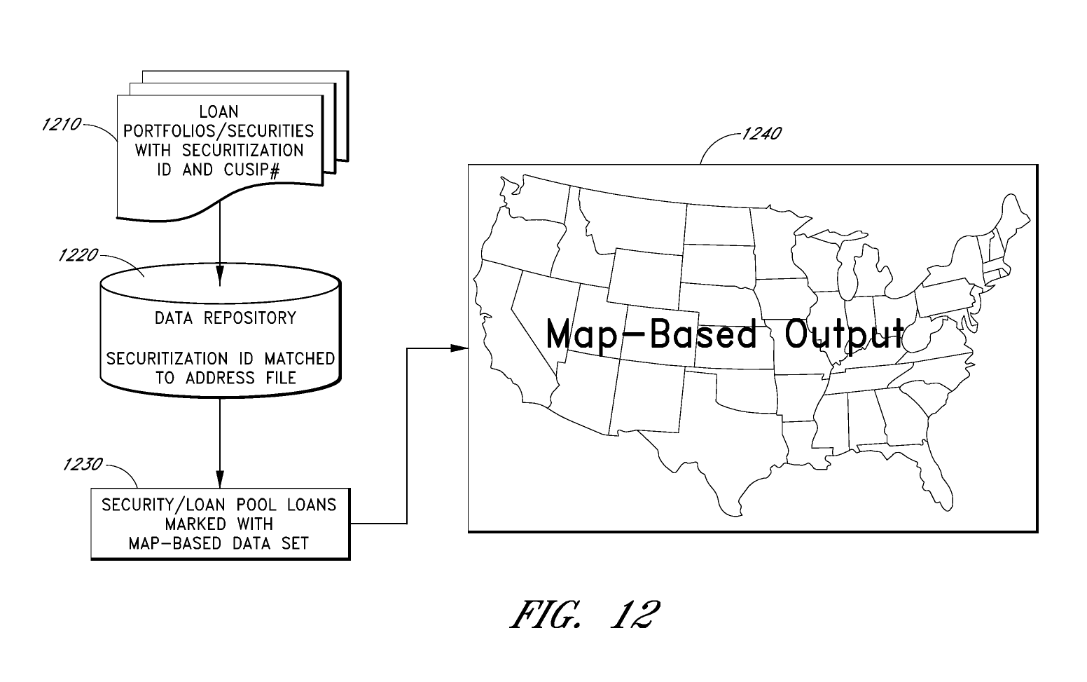

FIG. 13 is a block diagram illustrating one embodiment of a process of loan securitization. At 1302, a loan is given to a consumer borrower. Then at 1304, like loans are combined together into a loan pool by a lender. Pools can be sold into the market as a whole loan pools or collected as collateral for a mortgage backed security (MBS) deal. At 1306, each pool of loans throws off cash flows. If the market arbitrage for mortgage securities is strong, the cash flows are securitized into a mortgage backed security. Cash flows are typically structured into tranches. Depending on the rules set to direct the cash flows, each tranche will have distinct characteristics (e.g., coupon, maturity, and rating). Investors buy pieces of a tranche to hold or sell later. At 1308, investment bankers then sell the deals to investors. Investors may buy a partial or complete tranche from the deal. At 1310, servicers collect payment from borrowers, manage delinquency collection, and supervise foreclosures. The data is then reported to a master servicer. At 1312, the master servicer coordinates servicer activities for MBS deals and acts as one servicer voice to the trustee. The trustee oversees disbursement of borrower loan payments to holders of securities and reports collateral performance information via monthly remittance reports. At 1316, additional arbitrage may be performed by re-securitizing existing securities. At 1318, for example, an investment bank may combine the trances from different deals and create collateralized debt obligations (CDOs). At 1320, the CDO is split into tranches of bonds based upon the risk of aggregated future payments. Investors may buy pieces of a tranche to hold or sell later.

Currently, the most robust data currently available in the market to support credit analysis of private label structured securities is individual loan performance updated monthly through trustee reports. As some sophisticated market participants began to perform analysis at the loan level, it became apparent more information was needed and that the monthly loan facility performance is an ill-equipped solution to upgrading credit analysis in today's major credit downturn. Also, historical data on the newer loan types, such as sub-prime and adjustable rate mortgages, is limited and thus hampers market participants' ability to improve their analysis.

In addition, there exists no one source that blends the entirety of each consumer payment behavior with MBS/ABS deal performance. Therefore, investors and analysts of these securities are constrained in their ability to get refreshed insight into the credit behaviors of the consumers underlying the loans in the securities. Market participants are often left to project future performance based upon models using years-old consumer credit information, if they have any data to work with at all.

Thus, there is a need to update existing credit models or at the very least for the market to access more data on the underlying consumer so that more accurate assumptions can be used in analyzing and valuing MBS/ABS securities.

Embodiments of the present invention address these needs by providing data on consumer credit behavior, which may assist the task of predicting future credit behavior of loan borrowers and thus the performance of MBS/ABS securities.

As shown in FIG. 14, embodiments of the loan tracking and analysis system 100 include a managed structured platform 1400 that links data on consumers to loans, to collaterals, and/or to securities in the structured finance market. These embodiments, as with those described above, may provide a clearer picture of the credit health of private label deals backed by consumer loan collateral whose ratings are supported by subordinated structures and/or insurance wraps. As such, the instrument analysis may use more than a prepayment forecast assumption. Therefore, embodiments of the loan tracking and analysis system 100 may also take into account one or more of the following credit variables:
Constant default rate (CDR)
Delinquency rate
Severity or loss rate
Expected delays in foreclosure (due to compliance with local, state, and/or federal laws and regulations)

These variables are key data elements used for option adjusted spread (OAS) analysis of the securities. OAS models take the combination of assumptions and timelines for those assumptions and use a binomial tree methodology to identify potential paths from which to calculate a final yield or spread outcome. The OAS yield output portrays a value (compared to a static yield) that is based upon the overall expected performance.

In one embodiment, data obtained from one or more credit bureaus on the underlying consumer credit behavior are provided to market participants to help them gain a better understanding of borrower payments. In one embodiment, the consumer payment data attributes may be leveraged for use within the structured finance marketplace in the prepayment and default modeling methodologies, and may significantly improve forecasting capabilities.

Embodiments of the loan tracking and analysis system 100 could be used for various securities types, whether the security is backed by residential mortgages, auto/motorcycle/RV loans/leases, student loans, credit cards, marine/boat loans and other esoteric ABS types. These embodiments would allow any market participant to gain insight into the credit and assets for consumers underlying any security in an instant by simply defining the securities of interest to the system and receiving de-identified data (i.e., stripped of personal information) and analytics in return. As shown in FIG. 14, various relevant consumer and other financial data sources are collected for analysis. For example, loan, collateral, and deal data 1408 may include consumer ID and loan level data 1410 and collateral pool data, security and deal data 1412. Both types of data may be collected by or sent to servicers, issuers, trustees 1414. These entities may thus associate loan collaterals to deals and present report to investors. In one embodiment, the association is reported to or collected by the managed structured platform 1400 (as shown by the dotted arrow 1422). In addition, third party data vendor deal libraries 1416 may contain deal loan collateral data and security analytics and such data and analytics may also collected by or sent to the managed structured platform 1400 (as shown by the dotted arrow 1424). The managed structured platform 1400 may also collect consumer credit data 1418 and decision analytics from decision analytics model development module 1436. The decision analytics model development module 1436 may provide analytics based on econometric data 1428, including but not limited to macro economic data 1430, housing price data 1432, and interest rate data 1434.

The managed structured platform 1400 provides output 1420, which can be accessed either via a reporting tool 1406 (e.g., portal 180), standard data models 1402 and/or custom data models 1404.

Functions and Features

One or more embodiments provides a set of consumer credit data and analytics for whole loans and securities traded in the secondary markets. It may include a database and delivery platform that offers one or more of the following capabilities:
Consumer credit data (e.g., data obtained from a credit bureau) linked to loan level facility data
Consumer credit data (e.g., data obtained from a credit bureau) linked to instrument data
Consumer data linked to deal data.

Other features in some embodiments include:
A dataset of predefined data variables to be made available on a loan by loan basis.
The availability of an alert notification system to identify aggregated buckets of data migration from preset parameters.
A suite of scoring mechanisms to help forecast: debt prepayment rates, delinquency rates, default rates and loss rates.
A suite of reports that will offer detailed consumer data for individual loans through to the aggregated loan collateral backing a structured instrument and deal.

Sample Implementation

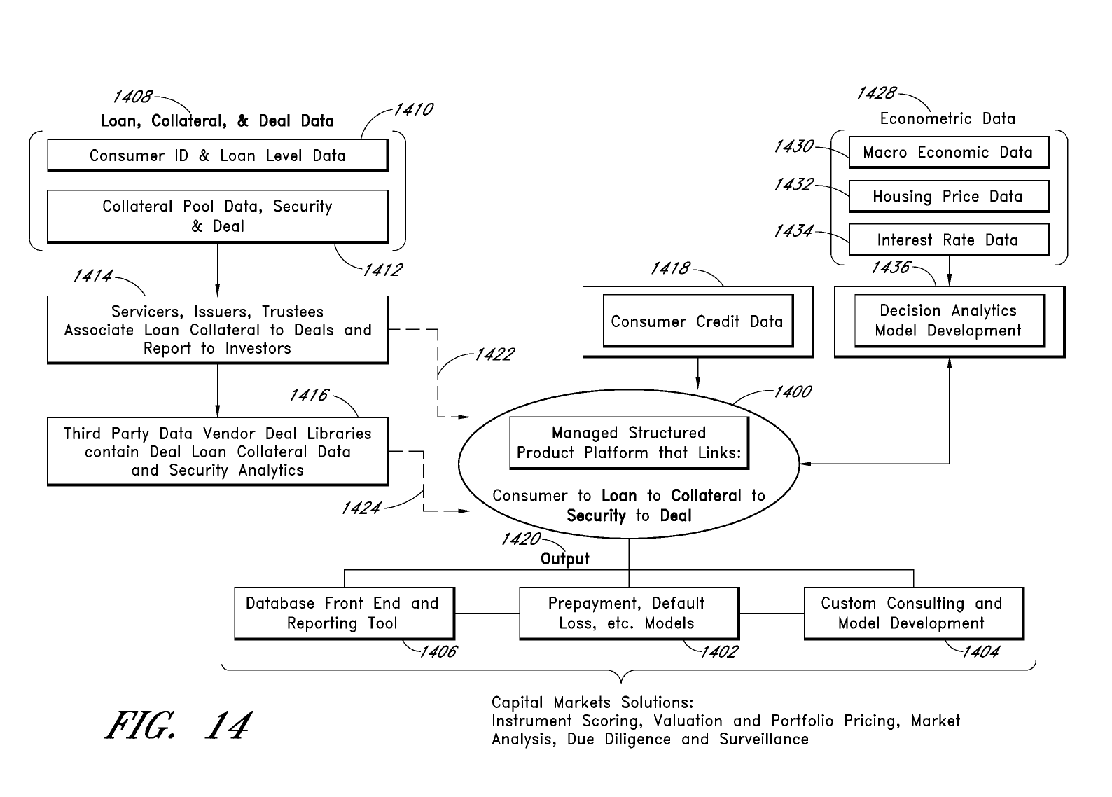

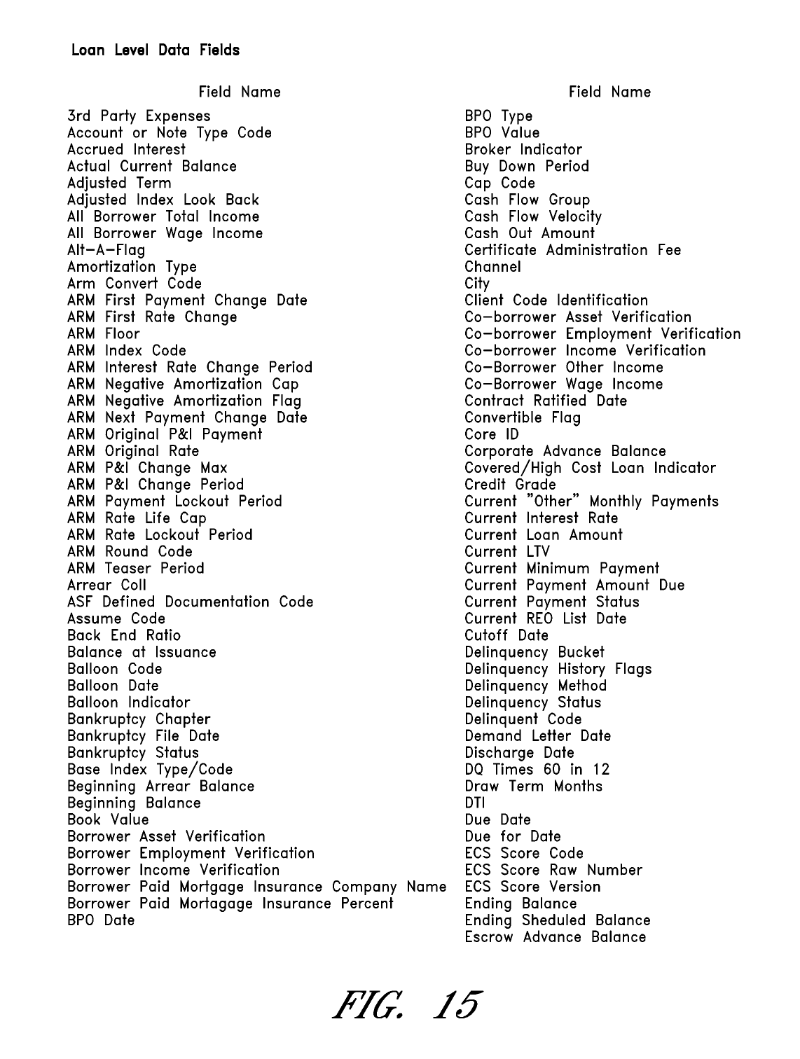

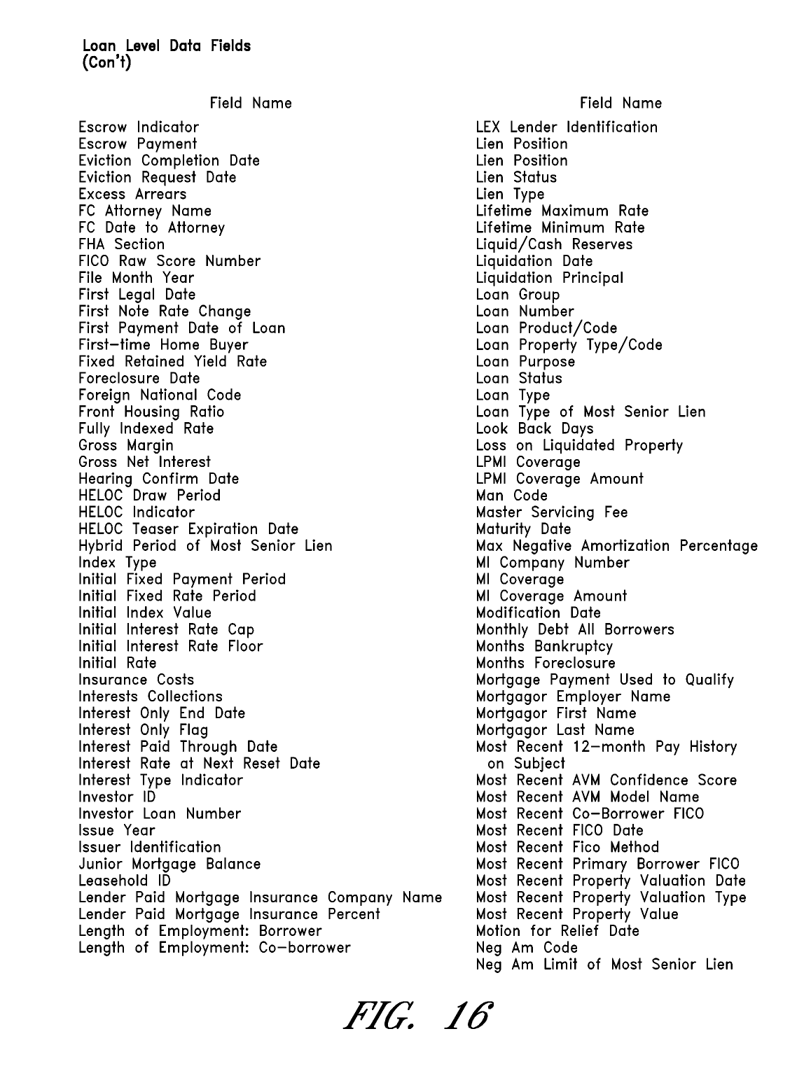

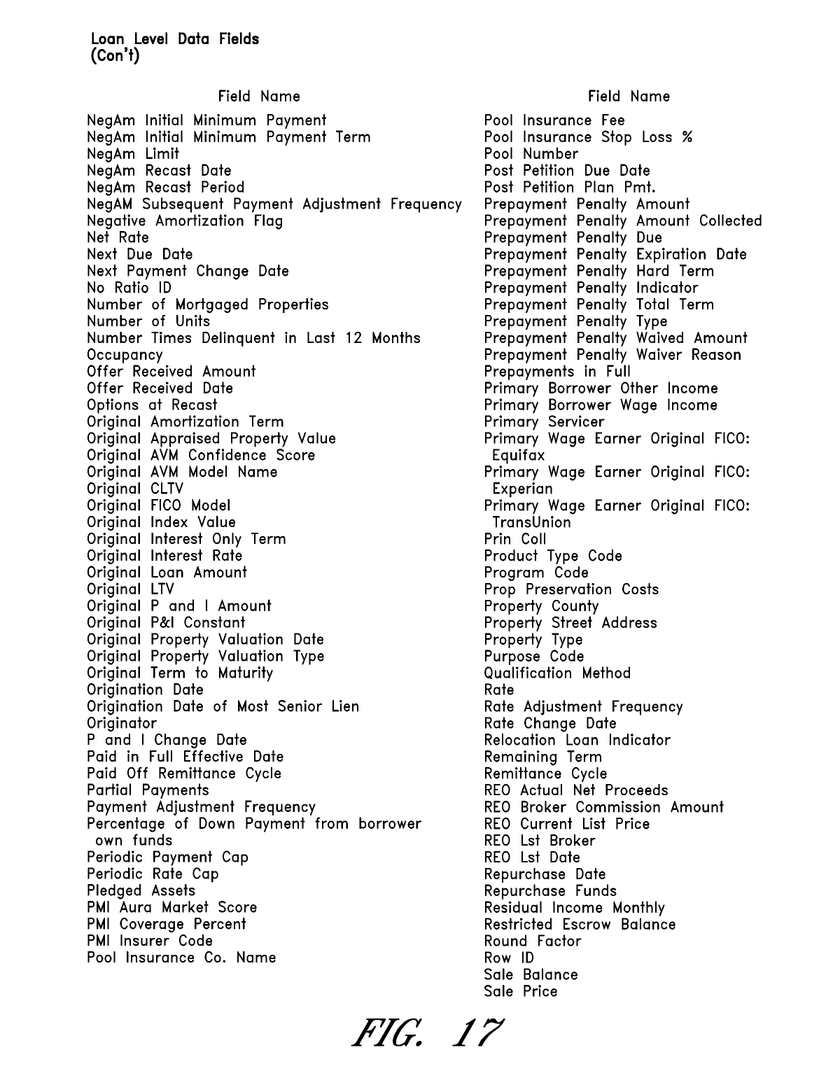

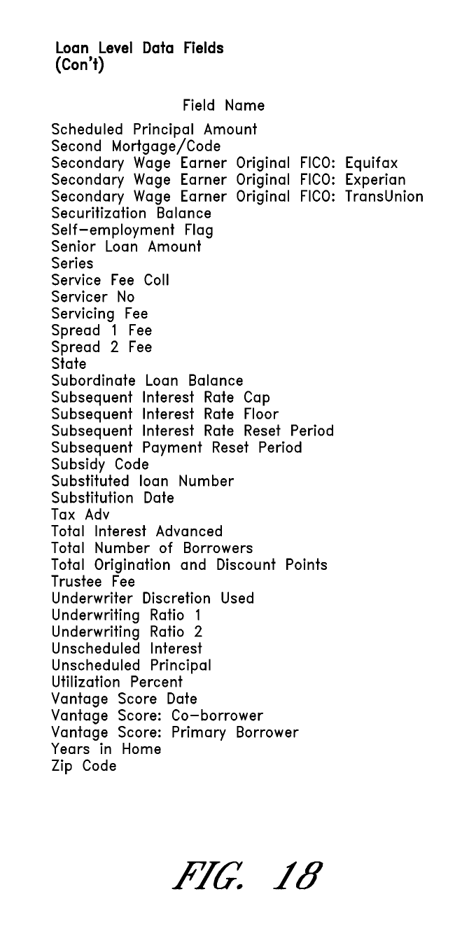

One or more embodiments of the loan tracking and analysis system 100 may be implemented as follows:
1. Data is loaded into a database (e.g., the data repository 172) according to the following parameters:
   Process the Deal, Security, Loan Facility and Consumer data types provided by either Servicers or Data providers.
   The Deal and its underlying data may be provided by Servicers and/or Data providers for categories such as Mortgage Loans, Student Loans, Auto Loans and Credit Cards.
   The Deal, Security, Loan Facility and Consumer data types may be provided in standard file formats. Certain Servicers or Data Providers may provide data in a non-standard format, which is then converted to a standard format.
   The Mortgage loan data may be refreshed monthly. The Credit Card/Auto loan data may be refreshed weekly. The Consumer data associated with Mortgage Loans, Student Loans, Credit Card, and Auto Loans may be refreshed weekly. Other frequencies may be used.
   Mortgage based Deal and Security (Class) data may be represented by 350 data points, or any other suitable quantity of data points. The Loan or Collateral data may be represented by 400 data points (or any other suitable quantity of data points) and it may include the consumer information associated with the Loans. Around 25 data points (or any other suitable quantity of data points) may be used to link the Deal with Loan data. Any other number of data points may be used to adapt to the different types of data received.
   Load the Deal, Security, Loan Facility and Consumer data types for different categories in a master consumer credit database.
2. Loans are assigned identification numbers as the loan data is cross-referenced against consumer data.
3. Data Structure
   The Deal, Security, Loan Facility and Consumer data types may be housed in a new database, e.g., the data repository 172 or another consumer credit database (e.g., master consumer credit database).
   Linkage may be established between the following data types:
      Consumer data in a consumer credit database with Loan data.
      Deal data with Loan data.
      Security data with Security sub-groups.
      In one embodiment, the Deal, Security, Loan data are archived for 7 years on a monthly basis. The archive data is used for historical trending of the Deals and/or Loans over a period of time and Model validation. However, other time periods and frequencies of archival may be used.
4. Batch Delivery
   The Batch delivery may include a linear output with the following sets of elements for every deal and the criteria provided by the client.
   Deal level information may be sent with Average Credit Score (e.g., Vantage Score), Average Model Score(s) from a Credit Bureau, and/or Summarized consumer data, etc.
   Loan level information may be sent with Model Score(s) from a Credit Bureau, and/or Consumer level attributes.
5. User Interface to the System (e.g., Web Application, the portal 180)
   A user interface (e.g., a web application) may be developed to deliver the Deal, Security, Loan Facility and/or Consumer data.
   The data for the user interface may be sourced from data repository 172 or one or more consumer databases.
   The user interface may provide the following output to the clients at different levels.
      Snapshot of Consumer behavior on Loans associated with a Deal.
      Analytical type reports.
6. Data Models
   The following new Models may be developed and housed in one ore more embodiments.
      Prepayment Model.
      Probability Default Model.
      Recovery Model.
   In one embodiment, one or more of the three models are implemented in a master consumer credit database platform.
   A model interface may be created for each model to get model score value.
   FIGS. 15-18 illustrate sample data fields that may be used in the data repository 172 or in the master consumer credit database in accordance with one embodiment.
      Depending on the embodiment, the methods described above may include fewer or additional steps, and the steps may be performed in different orders.

Linkage Hub Architecture

FIG. 19 shows a linkage hub architecture according to one embodiment. In one embodiment, the hub 1902 disseminates borrower-level consumer credit behavior insight to the debt capital markets while ensuring market participants and consumers that privacy concerns are addressed by removing personally identifiable data in the dissemination process. As shown, this hub 1902 links together the valuable and relevant information required to assess loans and securities by linking consumers to the loans, collaterals, securities, and deals. As shown in FIG. 19, the linkage hub 1902 facilitates the exchange of information. For example, a lender 1910 may forward along personal borrower data. Similarly another lender 1912 may forward consumer credit detail data. An ABS issuer 1914 may forward data 1954 including property and loan detail and ABS detail. An investor 1916 may provide consumer credit data 1956 and/or ABS detail 1958. A servicer 1918 may provide data 1960 which may include personal borrower data, consumer credit detail and property and loan detail. A trustee 1920 may provide data 1962 which may include loan detail and ABS detail. Finally, an investor 1922 may provide consumer credit detail 1962 and/or ABS detail 1966. In addition, a number of data sources such as non-credit data sources 1970 and home price source 1972 may be used as well.

The linkage hub 1902 may also be used to assess individual loans and loan pools. Once the correct identifying information of the consumer, loan product, and security is made available to the hub 1902, analysis can be sent in the form of detailed reports and analytics for use in evaluating the portfolio and future risk for each consumer tied to the loans of interest. The hub 1902 may also accept real-time updates to the linkage hub and enable third party information vendors of property values and consumer income to link into the hub for seamless distribution of all relevant information.

In one embodiment, any industry/market participant can obtain detailed borrower-level insight, as well as other relevant information, through the hub. In its architecture, the hub embodiment is purposely broad and represents not only consumer credit behavior data obtainable from one or more credit bureaus, but also enables linkage into other relevant third party data sources as well. Any valuable source of information may be linked to the hub for distribution to market participants using any appropriate, available identification information (e.g., security identification, unique loan number, or property identification).

In one embodiment, the information or analytics that may be disseminated by the linkage hub include:

(1) Refreshed borrower credit characteristics
a. Number and dollars for each type of obligation
b. Recent payment behavior and risk migration
c. Debt load and affordability

(2) Property valuation (via third party linking to hub in one embodiment)

(3) Borrower income (via third party linking to hub in one embodiment)

(4) Predictive analytics and scores
a. Default probability
b. Recovery probability
c. Loss severity (via third party linking to hub in one embodiment)

(5) Benchmarking and research information
a. By deal, loan product, geography, etc.

In one embodiment, these information and/or analytics may be accessed in the portal 180 environment shown in FIGS. 5 and 8-12, or sent out via alerts, reports, or in other formats as required by the requesting party. As shown in FIG. 19, information, predictive models, data, reports, and/or analytics may be distributed to issuers 1974, servicers 1976, investors 1978, CRAs 1980, insurers 1982, and/or regulators 1984 before, during, or after the securitization process.

In one embodiment, management of the linkage hub solution is dependent upon participation of the issuers of mortgage-backed securities and the (master) servicers of those securities. A cohesive transmission of consumer credit data relies on proper identification of the borrowers; this may be best accomplished by matching on the consumer name, address and social security number already securely housed at the hosting site (a credit bureau, for example). Inclusion of the consumer identification information (i.e. Obligor ID) with the loan number (i.e., Loan ID), property address details, loan details such as loan repayment terms and product types, and with residential mortgage-backed securities structure and credit enhancements (i.e., RMBS (Residential Mortgage Backed Securities) Detail), may allow matching of this information to the consumer and credit behavioral data obtainable from a credit bureau and predictive algorithms. The linkage hub addresses the market's need for transparency by linking data associated with the consumer borrower to any loan, collateral, security, and deal.

Once the linkage is accomplished, mortgage servicers may simply pass loan behavioral information to the hub, along with the loan identification and collateral updates. As new securities are issued, such information can be linked to the hub as well.

### Value of Borrower-Level Credit Data Insight

In some embodiments, the analysis system may take advantage of the insight that a borrower's behaviors on other credit obligations are early indicators for their ability and willingness to pay on their mortgage obligations. For example, one insight based on data collected on non-delinquent mortgages found the odds of default were four times greater over the upcoming twelve months if those borrowers had a significant recent change in their other credit obligations. Thus, certain embodiments can predict increased likelihood of default in the near future, for example, up to twelve months ahead of time, based on analyzing the consumer's behavior on other credit obligations. The types of predictive credit attributes that are highly predictive of future mortgage payment behavior include: recent delinquent payments on additional home equity lines of credit or mortgages, missed payments on credit cards and auto loans, and credit card usage such as exceeding credit limits.

With improved and accessible information through such early-warning indicators, market efficiency improves. In general, capital markets participants can use the insight to more effectively estimate future probability of default on consumer loans, thereby increasing the accuracy of their cash flow projections, better plan for loss mitigation issues, and more appropriately set loss reserve levels. Specifically, mortgage servicers may gain valuable lead-time for setting up loss mitigation programs and in identifying the most appropriate mortgages to target for loan modification programs that keep homeowners in their homes. Investors and other interested parties may gain insight on future losses well ahead of time, even before borrowers become delinquent on their mortgage, allowing for well-informed buying and selling decisions. As a result, investors may pay a premium price for assets with more predictable cash flow forecasts. Mortgage bond insurers, relied upon by the global capital markets to provide guaranties and credit enhancement, will obtain the ability to more accurately assess risk at the most granular of levels.

### CONCLUSION

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

1. A computerized system for analyzing loans involved in asset-backed securities and aspects of the asset-backed securities, comprising:
a credit migration database that stores consumer credit and financial data;
a data repository that assigns a securitization identifier (ID) to a loan and associates the securitization ID to a credit data record in the credit migration database that is associated with a borrower of the loan;
a tracking and analysis module configured to operate on the computerized system that, upon request, analyzes one or more loans by using the respective loan securitization IDs to:
retrieve the credit data records of the borrowers of the loans from the credit migration database before, during, or after a process in which the loans are securitized as asset-backed securities;
calculate a loan default risk or a prepayment risk based on payment records and account tradeline information within the credit data records that are associated with the borrowers; and
store the loan default risk or the prepayment risk in the data repository; and
a portal interface through which authorized users can access at least the loan default risk or the prepayment risk stored in the data repository, wherein the portal interface is configured to provide data or analytics to the authorized users via one or more network connections,
wherein the tracking and anal sis module is further configured to:
calculate models predictive of the performance of the asset-backed securities; and
store, in the data repository, models predictive of the performance of the asset-backed securities.

2. The computerized system of claim 1 wherein the tracking and analysis module is configured to analyze the asset-backed securities based on data related to one or more of the following: borrowers associated with the loans, underlying collaterals, participants in packaging the loans, and participants in processing the loans.

3. The computerized system of claim 1, further comprising a trigger notification module configured to operate on the computerized system, the trigger notification further configured to:
cause the tracking and analysis module to be executed based on a pre-determined frequency;
compare the loan default risk to a set of pre-defined threshold conditions; and
send notifications when at least one of the threshold conditions is met,
wherein the frequency and the threshold conditions are defined by a user of the system.

4. (canceled)

5. The computerized system of claim 1 wherein the loan default risk or prepayment risk is calculated based on other data that are not in the credit data records of the borrowers.

6. (canceled)

7. The computerized system of claim 1 wherein the credit data record and other data that are not in the credit data records form a unique PIN-based consumer data record.

8. The computerized system of claim 1 wherein the tracking and analysis module is further configured to store, in the data repository, analytics and non-credit data that are relevant to the calculation of the loan default risk or the prepayment risk.

9. (canceled)

10. The computerized system of claim 1 where in the models are calculated based on an option adjusted spread analysis.

11. The computerized system of claim 1 wherein the loan default risk is based on one or more of: historical loan performance, borrower default risk, the data and analytics, and collateral information stored in the data repository.

12. (canceled)

13. The computerized system of claim 12 wherein the collateral information relates to a real property, an automobile, consumer credit, commercial credit, loans, leases, potential inventory finance, or income generated from multi-media assets.

14. (canceled)

15. (canceled)

16. (canceled)

17. (canceled)

18. (canceled)

19. (canceled)

20. (canceled)

21. (canceled)

22. The computerized system of claim 1 wherein the tracking and analysis module determines whether the level of access authorization associated with a requester of the credit data records and strips personal identifying information or private information based on the determination.

23. A method of analyzing performance of loans, leases, and financial obligations based in part on borrower credit profiles and profiles of participants involved in asset-backed securities, comprising:
assigning a unique loan identifier to each of a plurality of loans;
associating one or more borrower credit data records with each of the loan identifiers;
using the loan identifiers to retrieve the credit data records of the respective borrowers of the plurality of loans;
analyzing the loans based on the retrieved credit data records of the borrowers, wherein the method is executed on a computing system;
performing the retrieving periodically at specified time intervals;
recording the retrieved credit data records; and
comparing the credit data records retrieved from different time periods to determine a trend in the collective performance of the plurality of loans.

24. (canceled)

25. (canceled)

26. (canceled)

27. The method of claim 23, further comprising:
assessing the past, current, or future value or performance of the plurality of loans.

28. The method of claim 27, further comprising:
providing benchmark comparison of the plurality of loans by comparing the loans to loans of similar types.

29. The method of claim 23, wherein the analyzing further comprises:
retrieving the credit data records of the borrowers from a credit database, wherein the credit data records further include a plurality of credit data attributes; and
using the credit data attributes in an option adjusted spread analysis.

30. (canceled)

31. The method of claim 23 wherein the trend includes one or more of payment behavioral changes, credit behavioral changes, and projection of future performances.

32. (canceled)

33. The method of claim 23, wherein the comparing determines the percentage of the plurality of loans having a negative status in a tradeline.

34. (canceled)

35. The method of claim 23, wherein the comparing determines the percentage of the plurality of loans having a delinquent status in a tradeline.

36. The method of claim 23, wherein the comparing determines the percentage of the plurality of loans having positive tradeline data.

37. (canceled)

38. (canceled)

39. (canceled)

40. (canceled)

41. (canceled)

42. (canceled)

43. (canceled)

44. (canceled)

45. (canceled)

46. The computerized system of claim 1 wherein the securitization ID comprise one or more of the following: a MIN (Mortgage Identification Number), an ASF (American Securitization Forum) Loan ID, parcel number, a VIN (Vehicle Identification Number), an ISIN (International Securities Identification Number), a deal name.

47. (canceled)

48. (canceled)

49. (canceled)

50. (canceled)

51. (canceled)

52. (canceled)

53. The computerized system of claim 1 wherein the tracking and analysis module:
retrieves the credit data records of the borrowers associated with the first plurality of loans periodically at specified time intervals, wherein the credit data records further include a plurality of credit data attributes;
records the retrieved credit data records in the data repository; and
compares the credit data records retrieved from different time periods to determine a trend in the collective performance of the first plurality of loans,
wherein the plurality of credit data comprise collateral valuation attributes.

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. A computerized system for analyzing loans involved in asset-backed securities and aspects of the asset-backed securities, comprising:
a credit database that stores consumer credit and financial data;
a data repository that assigns a securitization identifier to a loan and associates the securitization identifier to a credit data record in the credit migration database that is associated with a borrower of the loan;
a tracking and analysis module configured to operate on the computerized system that periodically analyzes one or more loans by using the respective loan securitization identifiers by:
retrieving the credit data records of the borrowers of the loans from the credit database before, during, or after a process in which the loans are securitized as asset-backed securities;
for one or more of the borrowers, calculating a propensity to repay one or more of the loans based on payment records and account tradeline information within the credit data records that are associated with an individual borrower;
for one or more of the borrowers, calculating a capacity to repay one or more of the loans based on income data associated with the individual borrower from an income database;
for one or more of the borrowers, calculating an ability to repay one or more of the loans based on collateral data from a collateral database; and
storing the calculated propensity to repay, the calculated capacity to repay, or the calculated ability to repay, in the data repository; and
an output module that provides authorized users data or analytics based on one or more of the propensity to repay, the capacity to repay, or the ability to repay.

73. The computerized system of claim 72 wherein the output module is a portal interface, wherein the portal interface is configured to provide data or analytics to the authorized users via one or more network connections.

74. The computerized system of claim 72 wherein the output module is a batch delivery system.

75. The computerized system of claim 72 wherein the data or analytics are provided at pool level.

76. The computerized system of claim 72 wherein the data or analytics are provided at loan level.

77. The computerized system of claim 72 wherein the data or analytics are stripped of personally identifiable information.
